(19) United States
(12) Patent Application Publication
(10) Pub. No.: US 2024/0129157 A1
(43) Pub. Date: Apr. 18, 2024

(54) DEVICE AND METHOD FOR CONTROLLING INDOOR APPLIANCES

(71) Applicant: Samsung Electronics Co., Ltd., Suwon-si (KR)

(72) Inventor: Taejun KWON, Suwon-si (KR)

(73) Assignee: Samsung Electronics Co., Ltd., Suwon-si (KR)

(21) Appl. No.: 18/390,260

(22) Filed: Dec. 20, 2023

Related U.S. Application Data
(63) Continuation of application No. PCT/KR2022/006973, filed on May 16, 2022.

(30) Foreign Application Priority Data
Jun. 21, 2021 (KR) 10-2021-0080274

(51) Int. Cl. H04L 12/28; G06F 3/16; H04B 17/318; H04M 1/72412; H04W 4/02

(52) U.S. Cl. CPC H04L 12/2816; G06F 3/167; H04B 17/318; H04M 1/72412; H04W 4/02

(57) ABSTRACT

Provided is a home appliance control device including: a communication interface; and at least one processor configured to transmit, based on a message output standby request being received from a mobile device, the message output standby request to at least one home appliance via the communication interface, determine whether a user exists within a first distance from at least one of the at least one home appliance, and control, based on determining that the user exists within the first distance from a first home appliance from among the at least one home appliance, the first home appliance to output a message corresponding to the message output standby request.

### TECHNICAL FIELD

Embodiments of the present disclosure relate to a home appliance control device, a home appliance control method, and a computer-readable recording medium.

### BACKGROUND ART

Recently, various functions are applied to smart home appliances, and an artificial intelligence (AI) service using the various functions is also provided. Moreover, as home appliances have a user interface such as a liquid crystal display (LCD), a speaker, or the like, the user interface may be used in various fields. However, as the user interface in the home appliances is used only for a dedicated service for each corresponding product, the user interface of the home appliances is underutilized. A display and a speaker are equipped in a home appliance function to deliver information to a user, and it is possible to provide the user with a convenient product use experience by providing various information by using them.

A device a user most frequently uses at home is a mobile device such as a communication terminal, a wearable device, or the like. Recently, almost every user uses a smartphone and is given a lot of information by using it. When a user receives information mostly via a mobile device, the information is received mostly via a multimedia messaging service (MMS) and a notification service. However, when a user is using a mobile device, the MMS or the notification service may interrupt the user and thus may cause a problem. Actually, many users, in customer service centers and Internet communities, ask about how to block notifications while gaming. Also, in a case where an urgent notification is issued while a user is making a call using a mobile device, there may be a problem in which the user cannot be provided the urgent notification.

### DISCLOSURE

### Technical Problem

Embodiments of the present disclosure provide a home appliance control device, a home appliance control method, and a computer-readable recording medium storing a computer program, wherein, when a mobile device is being used, the home appliance control device outputs a message, which was to have been output from the mobile device, to an appropriate neighboring home appliance.

### Technical Solution

According to an aspect of an embodiment of the present disclosure, a home appliance control device may include: a communication interface; and at least one processor configured to transmit, based on a message output standby request being received from a mobile device, the message output standby request to at least one home appliance via the communication interface, determine whether a user exists within a first distance from at least one of the at least one home appliance, and control, based on determining that the user exists within the first distance from a first home appliance from among the at least one home appliance, the first home appliance to output a message corresponding to the message output standby request.

Also, according to an embodiment of the present disclosure, the at least one processor may be configured to determine, based on detecting an operation of a user using the first home appliance, that the user exists within the first distance from the first home appliance.

Also, according to an embodiment of the present disclosure, the at least one processor may be configured to calculate a distance between the mobile device and each of the at least one home appliance, based on a strength of a Bluetooth low energy (BLE) communication signal between the mobile device and each of the at least one home appliance, and when a calculated distance between the mobile device and the first home appliance is within the first distance, determine that the user exists within the first distance from the first home appliance.

Also, according to an embodiment of the present disclosure, the at least one processor may be configured to broadcast the message output standby request to the at least one home appliance via the communication interface, based on determining that the mobile device is in a use state, and receive, after broadcasting the message output standby request, distance information indicating whether a user exists within the first distance, from each of the at least one home appliance.

Also, according to an embodiment of the present disclosure, the at least one processor may be configured to, based on determining that the user exists within the first distance, based on the distance information received from the first home appliance, control the first home appliance to output the message, and control, by transmitting message output completion information indicating an output of the message corresponding to the message output standby request to other home appliance excluding the first home appliance from among the at least one home appliance, the other home appliance not to output the message corresponding to the message output standby request, and stop an operation of receiving the distance information from the at least one home appliance.

Also, according to an embodiment of the present disclosure, the at least one processor may be configured to, based on determining that a user exists within the first distance from the first home appliance after broadcasting the message output standby request, transmit message content corresponding to the message output standby request to the first home appliance.

Also, according to an embodiment of the present disclosure, the at least one processor may be configured to, based on determining that the mobile device is switched from the use state to a message output-available state, broadcast a stop request for a message output standby mode in response to the message output standby request to the at least one home appliance, and stop receiving of the distance information from the at least one home appliance.

Also, according to an embodiment of the present disclosure, the at least one processor may be configured to, when the message output standby request is an urgent type, control a home appliance to output a message as an audio signal corresponding to the message output standby request, the home appliance including a speaker and being from among the at least one home appliance.

Also, according to an embodiment of the present disclosure, the at least one processor may be configured to, based on receiving a first message output standby request from a first mobile device and receiving a second message output standby request from a second mobile device, obtain a distance between the first mobile device and each of the at least one home appliance, and obtain a distance between the second mobile device and each of the at least one home appliance, and when it is identified that the first mobile device and the second mobile device exist within the first distance from the first home appliance, outputting, via the first home appliance, a message corresponding to a message output standby request transmitted from a mobile device which is closer to the first home appliance from among the first mobile device and the second mobile device.

Also, according to an embodiment of the present disclosure, the at least one processor may be configured to, based on receiving selection information about a home appliance set to output a message, transmit the message output standby request to the home appliance selected from the selection information from among the at least one home appliance, and not to transmit the message output standby request to a home appliance that is not selected from the selection information.

According to another aspect of an embodiment of the present disclosure, a home appliance control method may include: transmitting, based on a message output standby request being received from a mobile device, the message output standby request to at least one home appliance; determining whether a user exists within a first distance from at least one of the at least one home appliance; and controlling, based on determining that the user exists within the first distance from a first home appliance from among the at least one home appliance, the first home appliance to output a message corresponding to the message output standby request.

According to another aspect of an embodiment of the present disclosure, provided is a computer-readable recording medium having recorded thereon a program for performing, on a computer, the home appliance control method.

### DESCRIPTION OF DRAWINGS

FIG. 1 illustrates a home appliance control system according to an embodiment of the present disclosure.

FIG. 2 illustrates a block diagram of configurations of a home appliance control device, a mobile device, and a home appliance, according to an embodiment of the present disclosure.

FIG. 3 illustrates a home appliance control system according to an embodiment of the present disclosure.

FIG. 4 illustrates a home appliance control system according to an embodiment of the present disclosure.

FIG. 5 illustrates a home appliance control system according to an embodiment of the present disclosure.

FIG. 6 illustrates a flowchart of a home appliance control method according to an embodiment of the present disclosure.

FIG. 7 illustrates a flowchart of a procedure for outputting a message to a first electronic device, according to an embodiment of the present disclosure.

FIG. 8 illustrates a case where it is determined that a mobile device is in a use state, according to an embodiment of the present disclosure.

FIG. 9A illustrates a structure of a message output standby request according to an embodiment of the present disclosure.

FIG. 9B illustrates a message output standby request and message content, according to an embodiment of the present disclosure.

FIG. 10 illustrates an operation in which a home appliance control device receives use state information from a home appliance, according to an embodiment of the present disclosure.

FIG. 11 illustrates a procedure for broadcasting a message output standby request, according to an embodiment of the present disclosure.

FIG. 12 illustrates a procedure for outputting an urgent message, according to an embodiment of the present disclosure.

FIG. 13 illustrates a procedure for measuring a distance between a user and a home appliance, according to an embodiment of the present disclosure.

FIG. 14 illustrates a case in which a message output standby request is output from a plurality of mobile devices, according to an embodiment of the present disclosure.

FIG. 15 illustrates a case in which a message output standby request is output from a plurality of mobile devices, according to an embodiment of the present disclosure.

FIG. 16 illustrates a procedure for outputting a message when use of a home appliance is detected, according to an embodiment of the present disclosure.

FIG. 17 illustrates a method of measuring a distance to a mobile device when a home appliance does not have a Bluetooth low energy (BLE) communication module, according to an embodiment of the present disclosure.

FIG. 18 illustrates a procedure for stopping a message output standby mode, according to an embodiment of the present disclosure.

FIG. 19 illustrates a procedure for ending a message output mode, according to an embodiment of the present disclosure.

FIG. 20 illustrates a procedure for setting a type of a notification event to request a home appliance for a message output, according to an embodiment of the present disclosure.

FIG. 21 illustrates a procedure for setting a home appliance to be requested to output a message, according to an embodiment of the present disclosure.

FIG. 22 illustrates a structure of a home appliance control device according to an embodiment of the present disclosure.

### MODE FOR INVENTION

In the present specification, the principles of embodiments will now be described and embodiments thereof will now be disclosed to clearly define the scope of claims and for one of ordinary skill in the art to be able to perform embodiments disclosed in the claims. The disclosed embodiments may be implemented in many different forms.

Throughout the specification, like reference numerals denote like elements. Not all elements of the embodiments are described in the specification, and general features in the art to which the present disclosure belongs or redundant features among the embodiments are omitted. Throughout the specification, a term such as “module” or “unit” may be implemented as one of or a combination of at least two of software, hardware, and firmware, and according to embodiments, a plurality of “modules” or a plurality of “units” may be implemented as one element, or a “module” or a “unit” may include a plurality of elements.

In the descriptions of embodiments, detailed explanations of the related art are omitted when it is deemed that they may unnecessarily obscure the essence of the present disclosure. Also, numerals (e.g., “first”, “second”, and the like) in descriptions of the specification are used only to distinguish one element from another element.

Also, throughout the specification, it will be understood that, when an element is referred to as being “connected to” or “coupled with” another element, it can be directly connected to or coupled with the other element, or it can be indirectly connected to or coupled with the other element by having an intervening element interposed therebetween.

Hereinafter, operational principles of embodiments of the present disclosure and various embodiments thereof will be described in detail with reference to accompanying drawings.

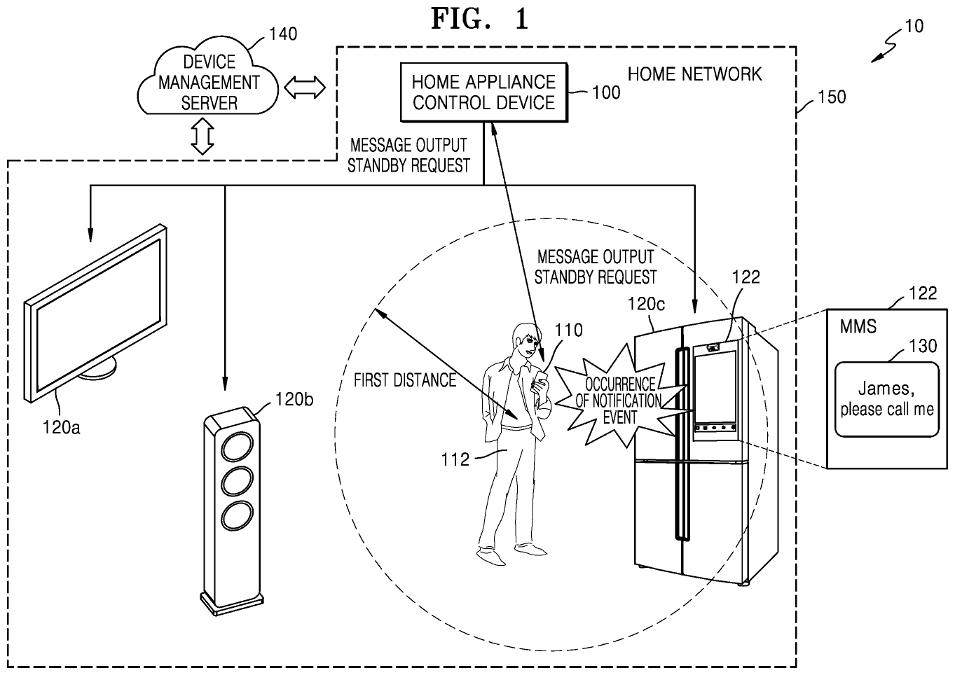

FIG. 1 illustrates a home appliance control system according to an embodiment of the present disclosure.

A home appliance control system 10 according to an embodiment of the present disclosure includes a home appliance control device 100, at least one mobile device 110, and one or more home appliances 120a, 120b, and 120c. The home appliance control device 100 is connected to the at least one mobile device 110 and the one or more home appliances 120a, 120b, and 120c by using short-range communication and thus communicates with them. The home appliance control device 100, the at least one mobile device 110, and the one or more home appliances 120a, 120b, and 120c communicate via a home network 150 formed by using short-range communication.

The home appliance control system 10 is provided at a preset indoor place. For example, the preset indoor place corresponds to a house, a room, an office, or the like. The preset indoor place may be a space in which the home network 150 to which the mobile device 110 is connected is established. For example, a user 112 registers the mobile device 110 in a first account of a device management server 140, and registers the one or more home appliances 120a, 120b, and 120c in the first account. When a device is registered in the first account, the mobile device 110 and the one or more home appliances 120a, 120b, and 120c which are registered in the first account communicate with each other via short-range communication in a house. In this manner, the mobile device 110 and the one or more home appliances 120a, 120b, and 120c which are registered in the same account form the home network 150.

The home appliance control device 100 is an electronic device connected to the home network 150. The home appliance control device 100 communicates with the mobile device 110 and the one or more home appliances 120a, 120b, and 120c via the home network 150. Also, the home appliance control device 100 may communicate with the device management server 140.

The device management server 140 is a server configured to control a plurality of devices and perform preset processing requested by the plurality of devices, while communicating with the plurality of devices. The device management server 140 stores a user account, and stores device information registered by the user 112 in each user account. The device management server 140 communicates with the plurality of devices, and exchanges a control signal and data. The device management server 140 may be connected to the plurality of devices via a long-range communication network. For example, the long-range communication network includes a legacy cellular network, a 5^{th} generation (5G) network, a next-generation communication network, Internet, a computer network (e.g.: a local area network (LAN) or a wide area network (WAN)), or the like.

The home appliance control device 100 may find and authenticate, via the device management server 140, an electronic device registered in the first account in which the mobile device 110 logs. The home appliance control device 100 according to embodiments of the present disclosure receives a message output standby request from the mobile device 110, and thus, outputs a message corresponding to the message output standby request to the home appliances 120a, 120b, and 120c that satisfy a preset condition. The home appliance control device 100 finds, via the device management server 140, the home appliances 120a, 120b, and 120c registered in the first account in which the mobile device 110 logs, and delivers the message output standby request to the home appliances 120a, 120b, and 120c registered in the first account.

The mobile device 110 corresponds to an electronic device that is carried by the user 112 and is configured to communicate with an external device. For example, the mobile device 110 may correspond to a communication terminal, a wearable device, a tablet PC, or the like. The mobile device 110 communicates with the device management server 140 and the external device via a long-range communication network. The mobile device 110 may be connected to a mobile communication network so as to perform various operations. According to an embodiment, the mobile device 110 is implemented in the form of a portable phone, a smartphone, or the like. The mobile device 110 may perform at least one function from among call reception, message reception, or application execution.

The mobile device 110 generates various types of notification events while performing operations of execution of an application function, call reception, message reception, or the like. For example, the mobile device 110 may generate notification events such as a call, a multimedia messaging service (MMS) message, an application notification, a system notification (e.g., a low battery, an update notification, etc.), or the like. When a notification event occurs, the mobile device 110 provides a notification via an output interface such as a display, a speaker, a vibration, or the like. When the mobile device 110 provides the notification, the mobile device 110 may temporarily stop an output of an ongoing process and may output information about the notification event. For example, in a case where the mobile device 110 receives an MMS message while reproducing a video, the mobile device 110 temporarily stops reproduction of the video and displays the MMS message.

In this manner, when a notification event occurs during a usage of the mobile device 110 and a message is output, the ongoing process is interrupted by the notification event and thus, the user 112 of the mobile device 110 may feel uncomfortable. In embodiments of the present disclosure, in a case where a notification event occurs while the user 112 uses the mobile device 110, a message related to the notification event occurring in the mobile device 110 is delivered to the home appliances 120a, 120b, and 120c connected to the home network 150 and then is output via the home appliances 120a, 120b, and 120c. With such configuration, the embodiments of the present disclosure prevent a situation in which the user 112 of the mobile device 110 is interrupted by a notification while using the mobile device 110. Also, the embodiments of the present disclosure may obtain an effect by which output interfaces of the home appliances 120a, 120b, and 120c may be efficiently used in a manner that a message related to a notification event of the mobile device 110 is output via the neighboring home appliances 120a, 120b, and 120c.

The home appliances 120a, 120b, and 120c are electronic devices configured to perform preset functions. The home appliances 120a, 120b, and 120c are arranged at preset positions in a house. For example, the home appliances 120a, 120b, and 120c may include a refrigerator, a kimchi refrigerator, a washing machine, a TV, an air conditioner, an air purifier, a robot cleaner, a washing machine, a clothing-care dresser, an oven, a microwave oven, induction cooktop/range, an audio output device, a smarthome hub device, or the like. The home appliances 120a, 120b, and 120c may be registered in a preset account registered in the device management server 140, and may communicate with the device management server 140. Also, the home appliances 120a, 120b, and 120c may communicate with the mobile device 110 via the home network 150. According to an embodiment, the home appliances 120a, 120b, and 120c may communicate with other home appliances 120a, 120b, and 120c via the home network 150.

The home appliances 120a, 120b, and 120c include a preset output interface 122. For example, the home appliances 120a, 120b, and 120c may include at least one of a display or a speaker. The home appliances 120a, 120b, and 120c output various information via the output interface 122. For example, the home appliances 120a, 120b, and 120c may output, via the output interface 122, operation information, state information, a notification, or the like of the home appliances 120a, 120b, and 120c. According to embodiments of the present disclosure, the home appliances 120a, 120b, and 120c receive a message output standby request from the mobile device 110, receive message content, and then output the message content via the output interface 122. For example, the home appliances 120a, 120b, and 120c may display the message content received from the mobile device 110 or may output the message content as an audio signal.

In a case where a notification event occurs while the user 112 is using the mobile device 110, the mobile device 110 transmits the message output standby request to the home appliance control device 100. When the home appliance control device 100 receives the message output standby request from the mobile device 110, the home appliance control device 100 controls the home appliances 120a, 120b, and 120c to output a message corresponding to the message output standby request, via the home appliance 120c positioned within a one-minute distance from the user 112. For example, in a case where an MMS message is received while the mobile device 110 reproduces a video, the mobile device 110 may transmit a message output standby request with respect to the MMS message to the home appliance control device 100, and the home appliance control device 100 may control the refrigerator 120c positioned within a one-minute distance from the user 112 to output the MMS message.

A message output standby request is a request signal delivered from the home appliance control device 100 to the home appliances 120a, 120b, and 120c. The message output standby request includes information indicating that there is a message to be output via the home appliances 120a, 120b, and 120c, and attribute information of the message to be output.

Based on the message output standby request received from the mobile device 110, the home appliance control device 100 generates a message output standby request to be transmitted to the home appliances 120a, 120b, and 120c. The message output standby request received from the mobile device 110 and the message output standby request to be transmitted to the home appliances 120a, 120b, and 120c may be the same data or data with different parts and formats.

The home appliance control device 100 may generate or convert the message output standby request to be transmitted to the home appliances 120a, 120b, and 120c, based on information, a protocol, a data format, etc. which are requested by each of the home appliances 120a, 120b, and 120c. Also, the home appliance control device 100 may differently generate a message output standby request, according to types of the home appliances 120a, 120b, and 120c. For example, the home appliance control device 100 may generate a message output standby request to be transmitted to the TV 120a to be different from a message output standby request to be transmitted to the refrigerator 120c.

The home appliance control device 100 transmits a message output standby request via the home network 150. Also, the home appliance control device 100 receives a message output standby request from the mobile device 110 via the home network 150. The home appliance control device 100 and the home appliances 120a, 120b, and 120c may access a long-range communication network. However, when information is delivered via the long-range communication network, the information may not be delivered in real time due to a network delay between a server and a terminal. Therefore, the embodiments of the present disclosure may obtain an effect by which a problem of a delay occurrence in the long-range communication network may be solved by using the home network 150, and a message output standby request from the mobile device 110 may be delivered in real time to the home appliance control device 100 and the home appliances 120a, 120b, and 120c

When the home appliance control device 100 receives the message output standby request, the home appliance control device 100 outputs a message corresponding to the message output standby request via at least one of the home appliances 120a, 120b, and 120c, the one being within a one-minute distance from the user 112. The home appliance control device 100 may detect the home appliances 120a, 120b, and 120c within a first distance from the user 112, based on information detected from the home appliances 120a, 120b, and 120c or a strength of a communication signal between the mobile device 110 and the home appliances 120a, 120b, and 120c. The first distance may be set by default or may be set by the user 112.

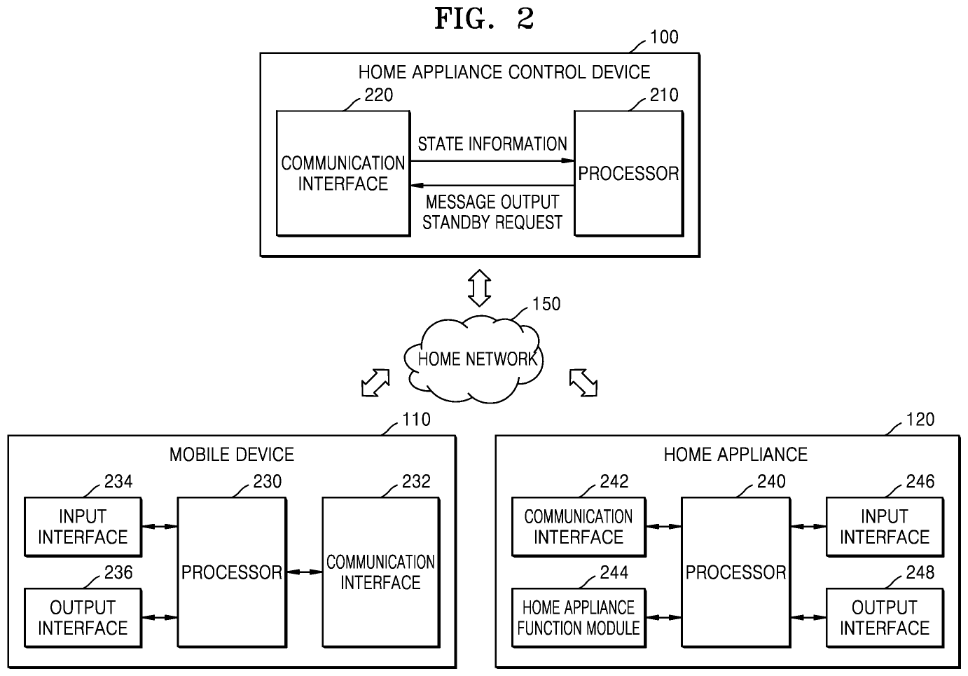

FIG. 2 illustrates a block diagram of configurations of a home appliance control device, a mobile device, and a home appliance, according to an embodiment of the present disclosure.

According to an embodiment of the present disclosure, the home appliance control device 100, the mobile device 110, and a home appliance 120 communicate via the home network 150. The home appliance 120 is a configuration corresponding to any one of the home appliances 120a, 120b, and 120c.

The home appliance control device 100 includes a processor 210 and a communication interface 220.

The processor 210 controls all operations of the home appliance control device 100. The processor 210 may be implemented as one or more processors. The processor 210 may perform a preset operation by executing an instruction or a command which is stored in a memory.

The communication interface 220 may communicate with an external device by wire or wirelessly. The communication interface 220 communicates with the mobile device 110 and the home appliance 120 via the home network 150. The home network 150 is a communication network between the mobile device 110 and the home appliance 120 which passed a preset authentication, and uses a short-range communication scheme. Also, the communication interface 220 communicates with the device management server 140. The communication interface 220 may communicate with the device management server 140 by using a long-range communication scheme.

The communication interface 220 may include a wireless communication module (e.g., a cellular communication module, a short-range wireless communication module, or a global navigation satellite system (GNSS) communication module) or a wired communication module (e.g., a local area network (LAN) communication module or a power line communication module). Also, the communication interface 220 may perform short-range communication, for example, may use Bluetooth, Bluetooth low energy (BLE), near field communication, wireless local area network (WLAN), ZigBee, infrared data association (IrDA) communication, Wi-Fi direct (WFD), ultra wideband (UWB), Ant+communication, or the like. As another example, the communication interface 220 may perform long-range communication, and for example, may communicate with an external device via a legacy cellular network, a 5G network, a next-generation communication network, Internet, a computer network (e.g.: a LAN or a WAN), or the like.

The communication interface 220 may establish communication with the home network 150, the mobile device 110, the home appliance 120, and the device management server 140, under control by the processor 210. The communication interface 220 receives a message output standby request from the mobile device 110 via the home network 150, and transmits the message output standby request to the home appliance 120. Also, the communication interface 220 transmits a control signal and data to the mobile device 110 and the home appliance 120 via the home network 150, or receives a control signal and data from the mobile device 110 and the home appliance 120.

According to an embodiment of the present disclosure, the home appliance control device 100 may further include a memory (not shown). The home appliance control device 100 stores at least one instruction and data in the memory. The processor 210 may perform a preset operation by executing the at least one instruction stored in the memory.

The mobile device 110 includes a processor 230, a communication interface 232, an input interface 234, and an output interface 236.

The processor 230 controls all operations of the mobile device 110. The processor 230 may be implemented as one or more processors. The processor 230 may perform a preset operation by executing an instruction or a command which is stored in the memory.

The communication interface 232 may communicate with an external device by wire or wirelessly. The communication interface 232 communicates with the home appliance control device 100 and the home appliance 120 via the home network 150. Also, the communication interface 232 communicates with the device management server 140. The communication interface 232 may communicate with the device management server 140 by using a long-range communication scheme.

The communication interface 232 may include a wireless communication module (e.g., a cellular communication module, a short-range wireless communication module, or a GNSS communication module) or a wired communication module (e.g., a LAN communication module or a power line communication module). Also, the communication interface 232 may perform short-range communication, for example, may use Bluetooth, BLE, near field communication, WLAN, ZigBee, IrDA communication, WFD, UWB, Ant+communication, or the like. As another example, the communication interface 232 may perform long-range communication, and for example, may communicate with an external device via a legacy cellular network, a 5G network, a next-generation communication network, Internet, a computer network (e.g.: a LAN or a WAN), or the like.

The communication interface 232 may establish communication with the home network 150, the home appliance control device 100, the home appliance 120, and the device management server 140, under control by the processor 230. The communication interface 232 transmits a message output standby request to the home appliance control device 100 via the home network 150. Also, the communication interface 232 transmits a control signal and data to the home appliance control device 100 and the home appliance 120 via the home network 150, or receives a control signal and data from the home appliance control device 100 and the home appliance 120.

The input interface 234 may receive a command or data to be used in an element (e.g.: the processor 230) of the mobile device 110 from an outer source (e.g.: a user) of the mobile device 110. The input interface 234 may include, for example, a touchscreen, a touch pad, a key, a microphone, a mouse, a keyboard, or a digital pen (e.g.: a stylus pen).

The output interface 236 outputs preset information, data, or the like related to an operation of the mobile device 110. The output interface 236 may include, for example, a display, a touchscreen, a speaker, a vibration device, or the like.

The home appliance 120 includes a processor 240, a communication interface 242, a home appliance function module 244, an output interface 248, and an input interface 246.

The processor 240 controls all operations of the home appliance 120. The processor 240 may be implemented as one or more processors. The processor 240 may perform a preset operation by executing an instruction or a command which is stored in a memory.

The communication interface 242 may communicate with an external device by wire or wirelessly. The communication interface 242 communicates with the home appliance control device 100 and the mobile device 110 via the home network 150. Also, the communication interface 242 communicates with the device management server 140. The communication interface 242 may communicate with the device management server 140 by using a long-range communication scheme.

The communication interface 242 may include a wireless communication module (e.g., a cellular communication module, a short-range wireless communication module, or a GNSS communication module) or a wired communication module (e.g., a LAN communication module or a power line communication module). The communication interface 242 may perform short-range communication, for example, may use Bluetooth, BLE, near field communication, WLAN, ZigBee, IrDA communication, WFD, UWB, Ant+communication, or the like. As another example, the communication interface 242 may perform long-range communication, and for example, may communicate with an external device via a legacy cellular network, a 5G network, a next-generation communication network, Internet, a computer network (e.g.: a LAN or a WAN), or the like.

The communication interface 242 may establish communication with the home network 150, the home appliance control device 100, the mobile device 110, other home appliance 120, and the device management server 140, under control by the processor 240. The communication interface 242 receives a message output standby request via the home network 150. Also, the communication interface 242 transmits a control signal and data to the home appliance control device 100 and the mobile device 110 via the home network 150, or receives a control signal and data from the home appliance control device 100 and the mobile device 110.

The home appliance function module 244 is a module configured to perform a preset function provided from the home appliance 120. For example, the home appliance function module 244 may include a cooler, a container, a door, a temperature sensor, a door opening/closing sensor, a lamp, or the like which are included in a refrigerator. As another example, the home appliance function module 244 may include a washing tub, a motor, a door, a door opening/closing sensor, a water supply unit, a drain unit, or the like which are included in a washing machine. As another example, the home appliance function module 244 may include a vacuum suction assembly, a dust bin, a brush, or the like which are included in a washing machine.

The home appliance function module 244 includes a sensor configured to sense a state of the home appliance 120. For example, the home appliance function module 244 may have a door opening/closing sensor to sense opening/closing of a door of a refrigerator, thereby sensing an opening or closing state of the door. As another example, the home appliance function module 244 may have a door opening/closing sensor to sense opening/closing of a door of a washing machine, thereby sensing an opening or closing state of the door.

The output interface 248 outputs preset information, data, or the like related to an operation of the home appliance 120. The output interface 248 may include, for example, a display, a touchscreen, a speaker, a vibration device, or the like. The display of the output interface 248 is provided at a preset position of a housing of the home appliance 120.

According to an embodiment of the present disclosure, the output interface 248 outputs a message delivered from the mobile device 110. When the home appliance control device 100 receives a message output standby request from the mobile device 110, the home appliance control device 100 detects a first home appliance positioned within a first distance from a user, and controls the first home appliance to output a message corresponding to the message output standby request. The output interface 248 of the first home appliance outputs the message delivered from the mobile device 110, in response to a request from the home appliance control device 100.

The input interface 246 may receive a command or data to be used in an element (e.g.: the processor 240) of the home appliance 120 from an outer source (e.g.: a user) of the home appliance 120. The input interface 246 may include, for example, a touchscreen, a touch pad, a dial, a microphone, or the like. The input interface 246 may receive a command for manipulation of the home appliance 120. For example, when the home appliance 120 corresponds to an air conditioner, the input interface 246 may receive an on/off command, a temperature setting input, an operation mode (e.g., air blowing, cooling, etc.), or the like which are related to the air conditioner. As another example, when the home appliance 120 corresponds to a washing machine, the input interface 246 may receive an on/off command, a washing mode (e.g., standard, delicate, etc.) setting input, a rinsing addition setting input, or the like which are related to the washing machine.

According to an embodiment of the present disclosure, when the home appliance 120 corresponds to a refrigerator, the input interface 246 may have a touchscreen and may receive, via the touchscreen, an input for manipulating the refrigerator. For example, the input interface 246 may receive an input related to a fridge temperature setting, a freezer temperature setting, or the like. Also, according to an embodiment of the present disclosure, the refrigerator may execute an application corresponding to a function such as Internet shopping, Internet browsing, memo, or the like, and a user may input a control signal related to the application via the input interface 246.

According to an embodiment of the present disclosure, the input interface 246 may receive an input related to a message corresponding to a message output standby request of the mobile device 110. For example, when the message that is received from the mobile device 110 and then is output is a message requesting a response, the input interface 246 may receive a response signal with respect to the message.

According to an embodiment of the present disclosure, the input interface 246 may receive a user input indicating the message output standby request of the mobile device 110 is checked. When the user input indicating that the message is checked is received from the user, the input interface 246 may transmit, to the home appliance control device 100, information indicating that the message is checked in the corresponding home appliance 120.

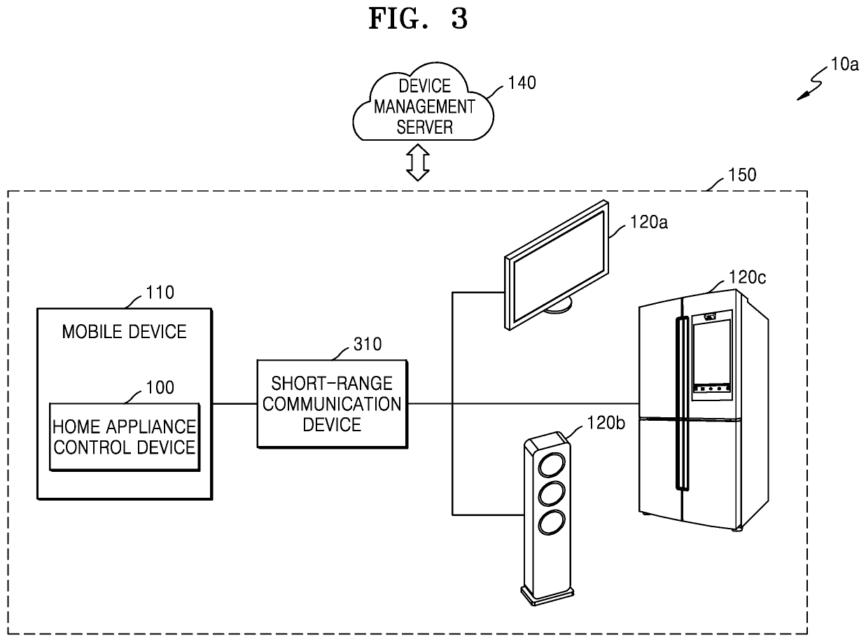

FIG. 3 illustrates a home appliance control system according to an embodiment of the present disclosure.

According to an embodiment of the present disclosure, in a home appliance control system 10a, the mobile device 110 may perform an operation of the home appliance control device 100. The mobile device 110 may perform the operation of the home appliance control device 100 by using the communication interface 232 and the processor 230 included in a corresponding device. In this case, when a notification event of outputting a message occurs in the corresponding device, the mobile device 110 may generate a message output standby request to the home appliances 120a, 120b, and 120c via the home network 150.

Also, according to an embodiment of the present disclosure, the mobile device 110 and the home appliances 120a, 120b, and 120c perform short-range communication via a short-range communication device 310. According to an embodiment of the present disclosure, the short-range communication device 310 may correspond to a router, an Ethernet hub, or the like. According to another embodiment of the present disclosure, the short-range communication device 310 may correspond to a router connected to a long-range communication network. The short-range communication device 310 may have a Wi-Fi chipset and an antenna, thereby performing a role of an access point (AP) with respect to a home network and a long-range network. According to an embodiment of the present disclosure, the home appliance control system 10a forms the home network 150 by the short-range communication device 310, and the mobile device 110 and the home appliances 120a, 120b, and 120c which are connected to the short-range communication device 310.

According to another embodiment of the present disclosure, the home appliance control device 100 may be implemented as an independent device that is physically separate from the mobile device 110 and the home appliances 120a, 120b, and 120c. In this case, the home appliance control device 100, the mobile device 110, and the home appliances 120a, 120b, and 120c may communicate via the short-range communication device 310.

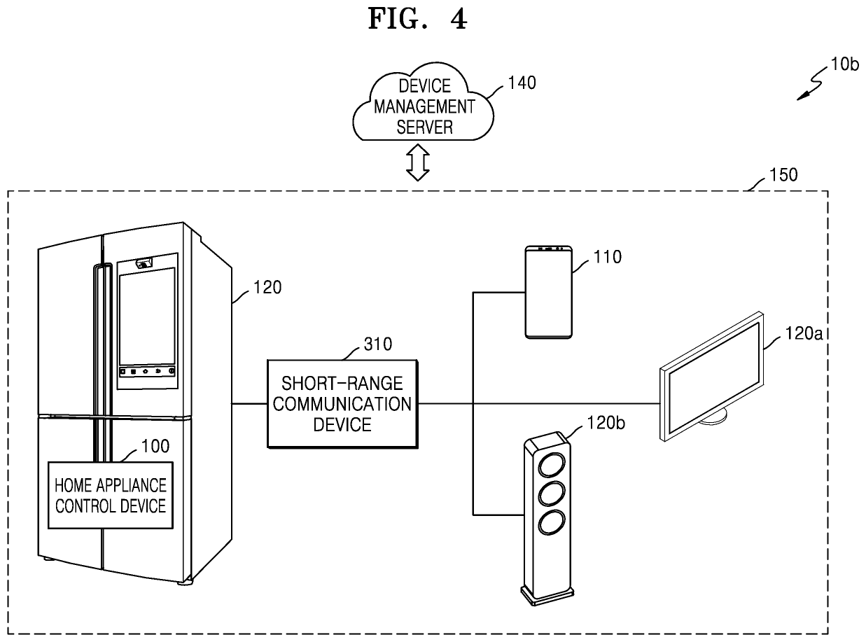

FIG. 4 illustrates a home appliance control system according to an embodiment of the present disclosure.

According to an embodiment of the present disclosure, in a home appliance control system 10b, the home appliance 120c may perform an operation of the home appliance control device 100. The home appliance 120c may perform the operation of the home appliance control device 100 by using the communication interface 242 and the processor 240 included in a corresponding device. The home appliance 120c may correspond to an always-on home appliance whose power is always turned on. Various types of home appliances 120c may perform the operation of the home appliance control device 100. According to an embodiment of the present disclosure, a refrigerator may perform a role of a hub device that performs the operation of the home appliance control device 100.

Also, according to an embodiment of the present disclosure, the home appliance 120c and other home appliances 120a and 120b perform short-range communication via the short-range communication device 310. Also, the home appliance 120c and the mobile device 110 perform short-range communication via the short-range communication device 310. According to an embodiment of the present disclosure, the home appliance control system 10b forms the home network 150 by the short-range communication device 310, and the mobile device 110 and the home appliances 120a, 120b, and 120c which are connected to the short-range communication device 310.

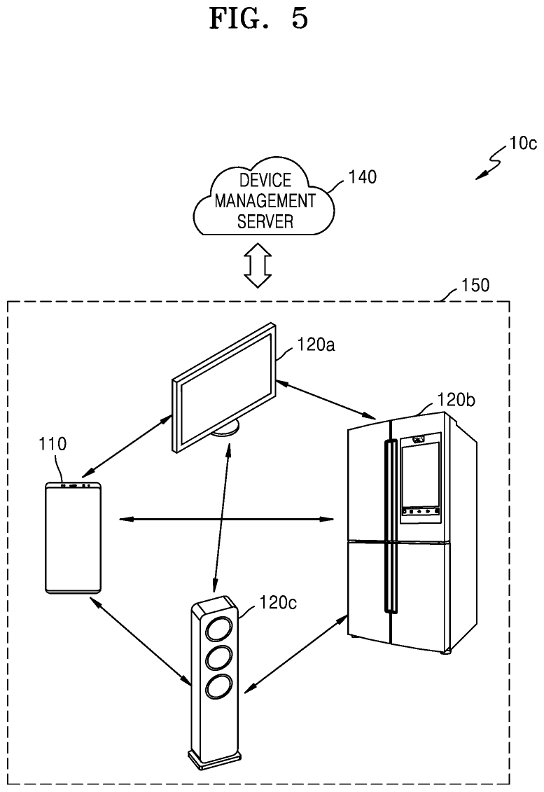

FIG. 5 illustrates a home appliance control system according to an embodiment of the present disclosure.

According to an embodiment of the present disclosure, the mobile device 110 and the home appliances 120a, 120b, and 120c configure the home network 150 by using a device-to-device scheme. For example, the mobile device 110 and the home appliances 120a, 120b, and 120c may perform device-to-device communication via BLE. As another example, the mobile device 110 and the home appliances 120a, 120b, and 120c may perform device-to-device communication by at least one of BLE, Bluetooth, or Wi-Fi direct. In a case where the home appliance control device 100 that is physically separate from the mobile device 110 and the home appliances 120a, 120b, and 120c is provided, the home appliance control device 100 may communicate with the mobile device 110 and the home appliances 120a, 120b, and 120c via device-to-device communication.

According to an embodiment of the present disclosure, the mobile device 110 may perform an operation of the home appliance control device 100, and the mobile device 110 and the home appliances 120a, 120b, and 120c may be connected via device-to-device communication. According to another embodiment of the present disclosure, one (e.g., the home appliance 120c) of the home appliances 120a, 120b, and 120c may perform an operation of the home appliance control device 100, and the mobile device 110 and the home appliances 120a, 120b, and 120c may be connected via device-to-device communication.

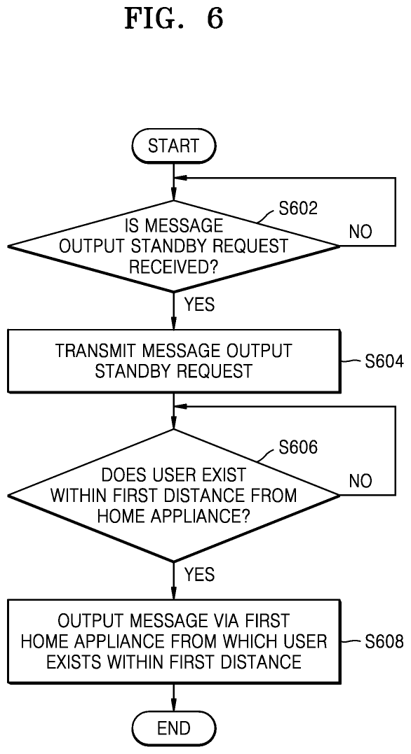

FIG. 6 illustrates a flowchart of a home appliance control method according to an embodiment of the present disclosure.

Each of operations of the home appliance control method according to an embodiment of the present disclosure may be performed by an electronic device in various forms connected to the mobile device 110 and the home appliances 120a, 120b, and 120c via the home network 150. The present disclosure will be described with reference to an embodiment in which the home appliance control device 100 according to embodiments of the present disclosure performs the home appliance control method. Therefore, embodiments described with reference to the home appliance control device 100 are applicable to embodiments with reference to the home appliance control method, and on the contrary, embodiments described with reference to the home appliance control method are applicable to embodiments with reference to the home appliance control device 100. The home appliance control method according to disclosed embodiments is not limited to that the embodiments are performed by the home appliance control device 100 but may be performed by an electronic device in various forms.

In operation S602, the home appliance control device 100 receives a message output standby request from the mobile device 110. The home appliance control device 100 receives the message output standby request from the mobile device 110 via the home network 150.

According to an embodiment of the present disclosure, the home appliance control device 100 may correspond to the mobile device 110, and the home appliance control device 100 may generate a message output standby request corresponding to a notification event detected in the mobile device 110. In this case, an operation in which the home appliance control device 100 receives the message output standby request may correspond to an operation of detecting a message output standby request corresponding to a notification event occurring in the mobile device 110 or an operation of generating a message output standby request corresponding to the notification event.

In operation S604, the home appliance control device 100 transmits the message output standby request to at least one home appliance 120a, 120b, or 120c via the home network 150. According to an embodiment, the home appliance control device 100 may broadcast the message output standby request to at least one home appliance 120a, 120b, or 120c. At least one home appliance 120a, 120b, or 120c connected to the home network 150 receives the message output standby request that is broadcast. Based on the message output standby request being received, at least one home appliance 120a, 120b, or 120c may generate user-distance information, may transmit the user-distance information to the home appliance control device 100, and may operate in a message output standby mode of outputting a message, based on a request of the home appliance control device 100.

In operation S606, the home appliance control device 100 determines whether a user exists within a first distance from at least one home appliance 120a, 120b, or 120c. The home appliance control device 100 receives user-distance information from each of the home appliances 120a, 120b, and 120c. According to an embodiment, the home appliance control device 100 may periodically receive user-distance information from each of the home appliances 120a, 120b, and 120c after a message output standby request is transmitted. The user-distance information may be obtained based on a strength of a BLE communication signal between an electronic device carried by a user and the home appliances 120a, 120b, and 120c. According to another embodiment, when a user is detected within a first distance, at least one of the home appliances 120a, 120b, and 120c transmits, to the home appliance control device 100, information indicating that the user is detected within the first distance from the corresponding home appliance 120a, 120b, or 120c.

Each home appliance 120a, 120b, or 120c transmits user-distance information or information indicating that a user is detected within the first distance, to the home appliance control device 100 via the home network 150. As the user-distance information or the information indicating that a user is detected within the first distance is received from the home appliance 120a, 120b, or 120c via the home network 150, the home appliance control device 100 may receive distance information or user-detection information in real time without a delay occurring in long-range communication.

In operation S608, the home appliance control device 100 controls message content to be output via the first home appliance 120a, 120b, or 120c from which the user is detected within the first distance. The home appliance control device 100 delivers the message content to the first home appliance 120a, 120b, or 120c. According to an embodiment, the home appliance control device 100 receives the message content from the mobile device 110, and transmits the message content received from the mobile device 110 to the first home appliance 120a, 120b, or 120c. According to another embodiment, the home appliance control device 100 delivers, to the mobile device 110, user-detection information indicating that a user is detected within the first distance from the first home appliance 120a, 120b, or 120c. The mobile device 110 transmits the message content to the first distance from the first home appliance 120a, 120b, or 120c, based on the user-detection information.

When the first home appliance 120a, 120b, or 120c receives the message content, the first home appliance 120a, 120b, or 120c outputs the message content via the input interface 246. For example, the first home appliance 120a, 120b, or 120c displays the message content on a display. As another example, the first home appliance 120a, 120b, or 120c outputs, via a speaker, an audio signal corresponding to the message content.

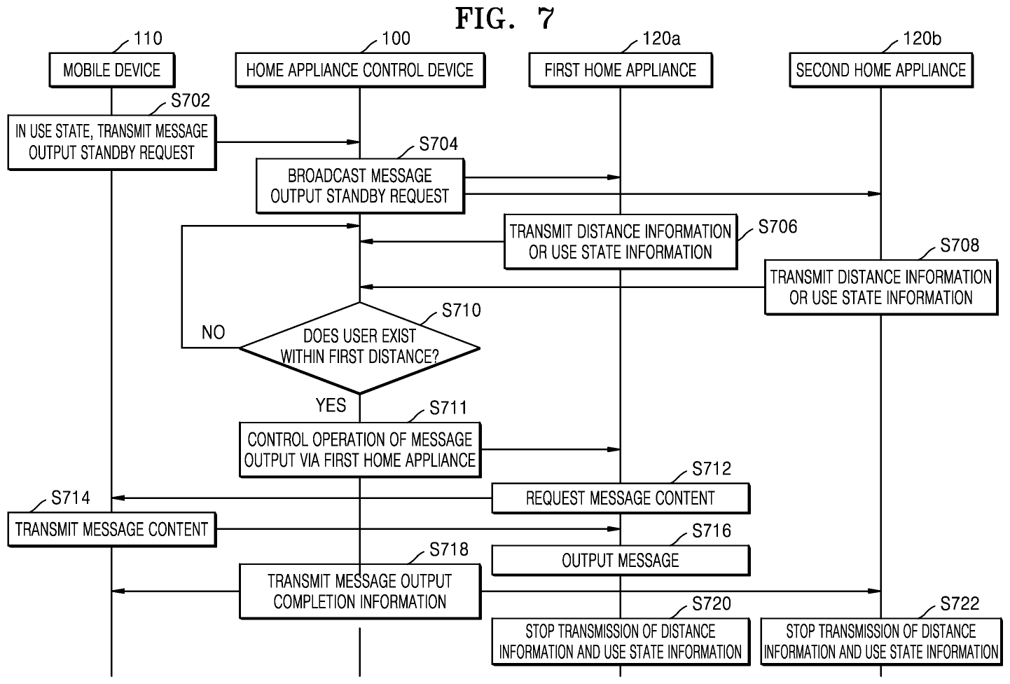

FIG. 7 illustrates a flowchart of a procedure for outputting a message to a first electronic device, according to an embodiment of the present disclosure. FIG. 7 illustrates an example in which a first electronic device corresponds to 120a, and a second electronic device corresponds to 120b will now be described. Also, an example in which a user is detected within a first distance from the first electronic device will now be described.

In operation S702, in a case where a notification event occurs and thus a message output is requested while the mobile device 110 is in a use state, the mobile device 110 generates and transmits a message output standby request to the home appliance control device 100. The home appliance control device 100 receives the message output standby request transmitted from the mobile device 110.

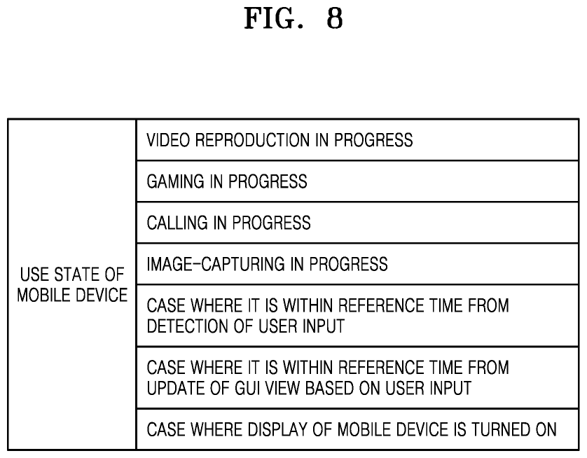

A case where the mobile device 110 is in a use state may be predefined based on an operation of the mobile device 110. The case where the mobile device 110 is in a use state will be described in detail with reference to FIG. 8.

FIG. 8 illustrates a case where it is determined that a mobile device is in a use state, according to an embodiment of the present disclosure.

According to an embodiment of the present disclosure, when the mobile device 110 is in a predefined operation state, the mobile device 110 determines that it is currently in a use state. The use state of the mobile device 110 may be determined in a product design stage or may be determined based on a user input. According to an embodiment of the present disclosure, cases in which a user of the mobile device 110 does not want to be interrupted by a notification may be defined as the use state of the mobile device 110. When interruption occurs while the user uses the mobile device 110, the user may feel that the user is interrupted. In order to prevent a situation in which the user feels that the user is interrupted, the mobile device 110 may define preset states as the use stage, and in the use state, the mobile device 110 may output a message generated due to a notification event via the home appliance 120a, 120b, or 120c.

According to an embodiment of the present disclosure, in at least one of a case of video reproduction, a case of gaming, a case of phone call, a case of image-capturing, a case where it is within a reference time from a time when a user input is detected, when it is within a reference time from a time when a graphical user interface (GUI) view is updated based on a user input, or a case where a display of the mobile device is turned one, the mobile device 110 may determine that the mobile device 110 is in the use state. A case where the use state is determined is not limited to cases shown in FIG. 8, and other cases may be added. Also, a case where it is determined that the mobile device 110 is in the use state may be some or all cases shown in FIG. 8. According to an embodiment of the present disclosure, it is possible that a user of the mobile device 110 selects, from among a plurality of predefined cases, a case in which a message corresponding to a notification event is output via the home appliance 120a, 120b, or 120c.

According to an embodiment of the present disclosure, the mobile device 110 may determine its use state, based on a function being executed. The mobile device 110 operates by executing a program. The program being executed in the mobile device 110 may include an operating system, middleware, and an application executable in the operating system.

When a particular application is being executed, the mobile device 110 may determine that it is in a use state. According to an embodiment, when the mobile device 110 executes at least one of a camera, a media player, a game, or a dialer, the mobile device 110 may determine that it is in a use state.

Also, according to an embodiment, the mobile device 110 may obtain information about an operation state of a particular function from middleware, and may determine that the mobile device 110 is in a use state, based on the information about the operation state. For example, the mobile device 110 may receive, from a Windows manager of the middleware, information indicating whether a particular application is in a full-screen mode, and when it is the full-screen mode, the mobile device 110 may determine that the mobile device 110 is in a use state. As another example, the mobile device 110 may receive, from the Windows manager of the middleware, information about a time when a GUI view is updated, and when it is within a reference time from the time when the GUI view is updated, the mobile device 110 may determine that the mobile device 110 is in a use state. As another example, the mobile device 110 may obtain, from a multimedia manager of the middleware, information indicating whether video content is being reproduced, and when the video content is being reproduced, the mobile device 110 may determine that the mobile device 110 is in a use state. As another example, the mobile device 110 may obtain, from a call manager of the middleware, information about whether an incoming/outgoing call occurs, and when the call occurs, the mobile device 110 may determine that the mobile device 110 is in a use state. As another example, the mobile device 110 may obtain, from a resource manager of the middleware, information about whether a display of the mobile device is turned on, and when the display is turned on, the mobile device 110 may determine that the mobile device 110 is in a use state.

According to another embodiment of the present disclosure, the mobile device 110 may determine whether the mobile device 110 is in a use state, based on a user input. The mobile device 110 may receive a user input via the input interface 234. For example, the mobile device 110 may include the input interface 234 such as a touchscreen, a voice recognition module, a key (button), a gesture recognition module, or the like. When the mobile device 110 detects a user input that is input via the input interface 234, the mobile device 110 determines that the mobile device 110 is in a use state within a reference time from a time when the user input is detected. For example, the mobile device 110 determines that the mobile device 110 is in a use state within a reference time from a time when touch via the touchscreen is detected. As another example, the mobile device 110 determines that the mobile device 110 is in a use state within a reference time from a time when a voice input via the voice recognition module is detected.

Next, with reference to FIG. 7 again, operations after operation S702 will now be described. In operation S704, the home appliance control device 100 broadcasts the message output standby request received from the mobile device 110 to the first home appliance 120a and the second home appliance 120b.

The home appliance control device 100 may broadcast the message output standby request to the first home appliance 120a and the second home appliance 120b via the home network 150. The home appliance control device 100 may simultaneously broadcast the message output standby request all receivers connected via the home network 150. A broadcasting range includes the mobile device 110 and the home appliances 120a and 120b connected via the home network 150. The home appliance control device 100 may transmit, by using a broadcast address, a packet including the message output standby request to all observers in the corresponding address range. That is, the home appliance control device 100 transmits the message output standby request by using a broadcast scheme, not a unicast scheme of transmitting a packet to a single reception device identified by a particular IP address. According to an embodiment, the home appliance control device 100 broadcasts the message output standby request to the home appliances 120a and 120b by using a BLE Advertise scheme. According to an embodiment of the present disclosure, as a message output standby request is transmitted using the broadcast scheme, it is possible to reduce a load of a communication operation for the home appliance control device 100 to transmit the message output standby request to a plurality of devices, and to simultaneously transmit the message output standby request to the plurality of devices.

When the first home appliance 120a and the second home appliance 120b receive the message output standby request, the first home appliance 120a and the second home appliance 120b operate in a message output standby mode of transmitting distance information or use state information to the home appliance control device 100. While the first home appliance 120a and the second home appliance 120b operate in the message output standby mode, the first home appliance 120a and the second home appliance 120b detect user-distance information or use state information, and transmit the distance information or the use state information to the home appliance control device 100.

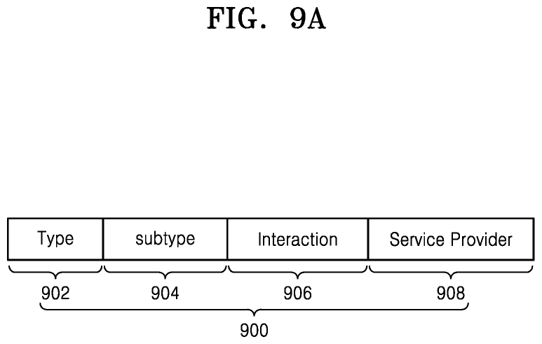

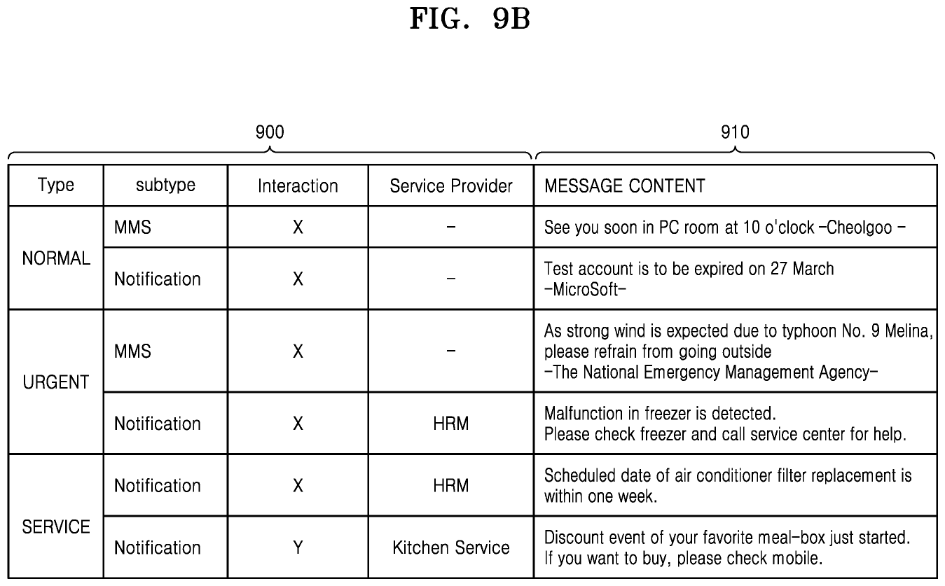

Next, with reference to FIGS. 9A and 9B, a message output standby request and message content will now be described.

FIG. 9A illustrates a structure of a message output standby request according to an embodiment of the present disclosure.

A message output standby request 900 includes attribute information of a message. The message output standby request 900 does not include contents of the message, i.e., message content, but includes information about an attribute of the message. According to an embodiment of the present disclosure, the message output standby request 900 includes type information 902, subtype information 904, interaction information 906, and service provider information 908. An attribute defined in each information of the message output standby request 900 will now be described in detail with reference to FIG. 9B.

According to an embodiment of the present disclosure, the message output standby request 900 may further include at least one of information (identification information, an address, etc.) of a mobile device transmitted the message output standby request 900, or identification information of the message output standby request.

FIG. 9B illustrates a message output standby request and message content, according to an embodiment of the present disclosure.

The message output standby request 900 may have message content 910 corresponding thereto. When the first home appliance 120a to output a message corresponding to the message output standby request 900 is determined after the message output standby request 900 is delivered, the message content 910 is transmitted to the first home appliance 120a.

Each information included in the message output standby request 900 may be defined as shown in FIG. 9B.

The type information 902 indicates a type of a message. According to an embodiment of the present disclosure, the type information 902 is defined to be one of normal, urgent, or service. The normal type indicates a message not having an urgent attribute. The normal type corresponds to an MMS message or a message of a messaging application (a chatting application, a message transmission application, etc.). The urgent type indicates a message having an urgent attribute. The urgent type is a message having an urgent attribute from among an MMS message or a message of the messaging application. The service type is a notification message generated from an application other than the messaging application.

The subtype information 904 is an attribute that is additionally applied to a message of each type. A normal-type message whose value for the type attribute 902 is normal may be defined as an MMS or a notification with respect to a value of the subtype information 904. A message generated by an MMS may have an MMS value as the subtype information 904, and a message generated by the messaging application may have a notification value as the subtype information 904. An urgent-type message whose value for the type attribute 902 is urgent may be defined as an MMS or a notification with respect to a value of the subtype information 904. Similar to the normal-type message, for the urgent-type message, a message generated by an MMS may have an MMS value as the subtype information 904, and a message generated by the messaging application may have a notification value as the subtype information 904. A service-type message whose type attribute 902 is service may be defined as a notification with respect to a value of the subtype information 904.

The interaction information 906 is information indicating whether an additional input is requested for the corresponding message. The additional input corresponds to a selection signal, a setting signal, text information, or the like which is input in correspondence to a corresponding message. According to an embodiment of the present disclosure, the normal-type message and the urgent-type message are defined to be negative (X) with respect to a value of the interaction information 906. Also, a value of the interaction information 906 of the service-type message is defined to be positive (Y) when interaction is requested, and is defined to be negative (X) when interaction is not requested.

The service provider information 908 indicates information about a service provider that provides a corresponding message. According to an embodiment, a service provider value may not be defined for a basic function provided by the operating system or a notification provided by an application. Also, an MMS may not be defined with respect to a value of the service provider information 908. In a case of a service-type message, as illustrated in FIG. 9B, a value of the service provider information 908 may be defined as a value such as HRM, Kitchen Service, or the like.

The mobile device 110 may obtain each information included in the message output standby request 900, from an application generating a notification.

The message content 910 indicates content of a message. For example, as illustrated in FIG. 9B, a normal-type MMS message may have message content “See you soon in PC room at 10 o′clock—from Cheolgoo” as the message content 910.

Referring back to FIG. 7, an operation after operation S704 of broadcasting a message output standby request will now be described.

When the message output standby request is broadcast (S704), the first home appliance 120a and the second home appliance 120b receive the message output standby request. In addition to the first home appliance 120a and the second home appliance 120b, the mobile device 110 and other home appliances or electronic devices connected to the home network 150 may receive the message output standby request.

In operation S706, based on the message output standby request being received, the first home appliance 120a transmits information about a distance between the first home appliance 120a and a user to the home appliance control device 100. According to an embodiment, the distance information corresponds to a distance value generated by measuring the distance from the first home appliance 120a to the user. According to another embodiment, the distance information is distance information indicating whether the user is detected within a first reference distance from the first home appliance 120a.

According to an embodiment of the present disclosure, in operation S706, the first home appliance 120a transmits use state information of the first home appliance 120a. The use state information is information indicating whether an operation in which a user uses the first home appliance 120a is detected in the first home appliance 120a. When the user manipulates the first home appliance 120a, a use operation of the user may be detected from the first home appliance 120a.

In operation S708, based on the message output standby request being received, the second home appliance 120b transmits information about a distance between the second home appliance 120b and a user to the home appliance control device 100. According to an embodiment of the present disclosure, in operation S708, the second home appliance 120b transmits use state information of the second home appliance 120b. For example, the second home appliance 120b may transmit use state information indicating that a use operation of the user is not detected, to the home appliance control device 100.

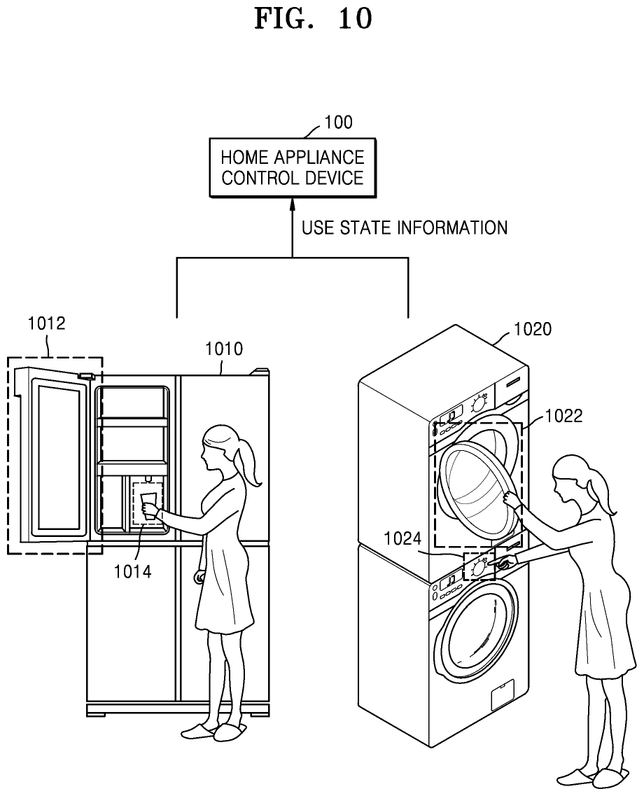

With reference to FIG. 10, an operation in which the home appliance control device 100 receives use state information from the home appliance 120a or 120b will now be described.

FIG. 10 illustrates an operation in which a home appliance control device receives use state information from a home appliance, according to an embodiment of the present disclosure. While FIG. 10 is described with an example of the first home appliance 120a, home appliances other than the first home appliance 120a may generate and transmit use state information to the home appliance control device 100.

The first home appliance 120a may detect an operation in which a user manipulates the first home appliance 120a. The first home appliance 120a may include the home appliance function module 244 for performing a unique function, and the input interface 246. The first home appliance 120a may detect a user operation of manipulating the home appliance function module 244 or the input interface 246. The first home appliance 120a may have at least one sensor configured to detect states of elements of the home appliance function module 244, and may detect a user operation of manipulating the home appliance function module 244, based on the sensor-detected value.

The home appliance function module 244 has a mechanical structure for performing a unique function of the first home appliance 120a. The first home appliance 120a may have a sensor configured to detect a state of the home appliance function module 244. The first home appliance 120a may detect a use operation in which a user manipulates the first home appliance 120a, based on a detection value of the sensor. When the first home appliance 120a detects the use operation, the first home appliance 120a generates use state information indicating that the use operation of the user is detected, and transmits the use state information to the home appliance control device 100.

For example, the first home appliance 120a corresponds to a refrigerator 1010. The refrigerator 1010 may include a door 1012. The refrigerator 1010 includes a door sensor configured to detect whether the door 1012 is in an open state. When the door sensor detects that the door 1012 is in an open state, the refrigerator 1010 determines that a user is using the refrigerator 1010. When the refrigerator 1010 determines that the user is using the refrigerator 1010, the refrigerator 1010 generates use state information indicating a use operation of the user is detected in the refrigerator 1010, and transmits the use state information to the home appliance control device 100.

As another example, the refrigerator 1010 includes a water purifier 1014. The refrigerator 1010 may include a sensor configured to detect an operation of manipulating the water purifier 1014. For example, the refrigerator 1010 includes a sensor configured to detect a state of a control panel to control a water dispenser of the water purifier 1014. The refrigerator 1010 determines a use state, based on a sensor-detected value of a sensor of the control panel to control a water dispenser. When the refrigerator 1010 determines that water is being dispensed, based on the sensor-detected value, the refrigerator 1010 generates use state information indicating a use operation of a user is detected in the refrigerator 1010, and transmits the use state information to the home appliance control device 100.

As another example, the first home appliance 120a corresponds to a washing machine 1020. The washing machine 1020 may include a door 1022. The washing machine 1020 includes a door sensor configured to detect whether the door 1022 is in an open state. When the door sensor detects that the door 1022 is in an open state, the washing machine 1020 determines that a user is using the washing machine 1020. When the washing machine 1020 determines that the user is using the washing machine 1020, the washing machine 1020 generates use state information indicating a use operation of the user is detected in the washing machine 1020, and transmits the use state information to the home appliance control device 100.

As another example, the washing machine 1020 includes an input interface 1024. The input interface 1024 includes a dial, a touch key, or the like. When a user input of manipulating the input interface 1024 is detected, the washing machine 1020 determines that the user is using the washing machine 1020. When the washing machine 1020 determines that the user is using the washing machine 1020, the washing machine 1020 generates use state information indicating a use operation of the user is detected in the washing machine 1020, and transmits the use state information to the home appliance control device 100.

Referring back to FIG. 7, an operation after operations S706 and S708 will now be described.

In operation S710, the home appliance control device 100 determines whether a user exists within a first distance from the first home appliance 120a, based on distance information or use state information received from the first home appliance 120a. Also, in operation S710, the home appliance control device 100 determines whether a user exists within the first distance from the second home appliance 120b, based on distance information or use state information received from the second home appliance 120b.

According to an embodiment of the present disclosure, the home appliance control device 100 receives information of a distance between the first home appliance 120a and a user, determines whether the distance between the first home appliance 120a and the user is smaller than the first distance, and determines whether the user exists within the first distance from the first home appliance 120a. Similar to the first home appliance 120a, the home appliance control device 100 determines, for the second home appliance 120b, whether the user exists within the first distance from the second home appliance 120b.

According to another embodiment of the present disclosure, the home appliance control device 100 receives information indicating whether the user is detected within the first distance, from the first home appliance 120a and the second home appliance 120b. When the home appliance control device 100 receives the information indicating whether the user is detected within the first distance, from one of the first home appliance 120a and the second home appliance 120b, the home appliance control device 100 determines that the user exists within the first distance from the corresponding home appliance.

According to another embodiment of the present disclosure, the home appliance control device 100 receives, from the first home appliance 120a or the second home appliance 120b, use state information indicating that an operation of a user using a corresponding home appliance is detected. When the home appliance control device 100 receives the use state information from one of the first home appliance 120a or the second home appliance 120b, the home appliance control device 100 determines that the user exists within a first distance from the home appliance from which the use state information is received.

FIG. 7 is described with reference to an example in which it is determined that a user exists within a first distance from the first home appliance 120a.

In operation S711, when it is determined that a user exists within a first distance from the first home appliance 120a, the home appliance control device 100 controls an operation for outputting a message via the first home appliance 120a. The home appliance control device 100 controls the first home appliance 120a to request the mobile device 110 for message content. Also, the home appliance control device 100 may transmit, to the first home appliance 120a or the mobile device 110, authority information for the first home appliance 120a to obtain the message content from the mobile device 110.

When it is determined that a user exists within a first distance from the first home appliance 120a, in operation S712, the first home appliance 120a requests the mobile device 110 for message content. The first home appliance 120a generates a message content request including message identification information, information (identification information, an address, etc.) of the first home appliance 120a, and transmits the message content request to the mobile device 110. The first home appliance 120a transmits the message content request to the mobile device 110 via the home network 150.

According to an embodiment of the present disclosure, the first home appliance 120a requests the mobile device 110 for message content, based on information about the mobile device 110, the information being include in a message output standby request. The message output standby request may include a medium access control (MAC) address of the mobile device 110. The first home appliance 120a requests the mobile device 110 for message content by using the MAC address of the mobile device 110 included in the message output standby request. The message content request may be performed in a unicast scheme by which the first home appliance 120a accesses the address of the mobile device 110 and requests the message content.

According to another embodiment of the present disclosure, the first home appliance 120a broadcasts the message content request via the home network 150. The first home appliance 120a transmits the message content request to the mobile device 110 by broadcasting the message content request. When the message content request is broadcast, the home appliance control device 100 and other home appliances 120b which are connected to the home network 150 receive the message content request. The home appliance control device 100 and other home appliances 120b may identify, by receiving the message content request, that an output of a message corresponding to the message output standby request is completed.

According to another embodiment of the present disclosure, the first home appliance 120a transmits the message content request to the home appliance control device 100. When the home appliance control device 100 receives the message content request, the home appliance control device 100 transmits the message content request to the mobile device 110 that has output message output information corresponding to the message content request.

Next, in operation S714, the mobile device 110 transmits message content to the first home appliance 120a, based on the message content request being received. The message content request includes information about the first home appliance 120a. The mobile device 110 transmits message content to the first home appliance 120a, based on information about the first home appliance 120a, the information being included in the message content request.

According to an embodiment of the present disclosure, the mobile device 110 converts message content into a data form processible by the first home appliance 120a and transmits it. A maximum size, a format, a type, or the like of message content which are processible by the first home appliance 120a may be predetermined. For example, the first home appliance 120a may output only text information, may output message content of up to 100 words, and may process only a file with.txt extension. In this case, the mobile device 110 extracts only text information excluding image or video content from message content, and when the text information exceeds 100 words, the mobile device 110 removes a part exceeding 100 words and generates a file including the message content into a .txt file. The mobile device 110 converts message content into a format that is compatible with the first home appliance 120a, and transmits the converted message content to the first home appliance 120a.

According to another embodiment of the present disclosure, the mobile device 110 transmits message content to the home appliance control device 100. The home appliance control device 100 receives the message content and converts the message content into a format to be compatible with the first home appliance 120a. The home appliance control device 100 may convert the message content, based on a maximum size, a format, a type, or the like which are processible by the first home appliance 120a. The home appliance control device 100 transmits the converted message content to the first home appliance 120a.

When the first home appliance 120a receives the message content, in operation S712, the first home appliance 120a outputs a message including the message content. The first home appliance 120a outputs the message via the output interface 248. For example, the first home appliance 120a displays, on a display, the message including the received message content. As another example, the first home appliance 120a outputs the message of the received message content as an audio signal via a speaker. According to an embodiment, the first home appliance 120a may include a text-to-speech (TTS) module, and may convert, by using the TTS module, the message of the received message content into the audio signal and may output it.

When an output of the message from the first home appliance 120a is completed, message output completion information indicating completion of the output of the message is transmitted to the mobile device 110 and the second home appliance 120b. The message output completion information may be output by the first home appliance 120a or the home appliance control device 100.

According to an embodiment, completion of the output of the message may be identified based on the message output completion information output from the first home appliance 120a. For example, when an output of a message is completed in operation S716, the first home appliance 120a transmits message output completion information to the home appliance control device 100. When the home appliance control device 100 receives the message output completion information from the first home appliance 120a, the home appliance control device 100 transmits the message output completion information to the mobile device 110 and the second home appliance 120b.

According to another embodiment, completion of the output of the message may be identified based on a message content request being transmitted from the first home appliance 120a. When the first home appliance 120a determines that a user exists within a first distance from the first home appliance 120a, the first home appliance 120a transmits the message content request to the mobile device 110. When the first home appliance 120a transmits the message content request, the mobile device 110 may identify that a message is to be output from the first home appliance 120a. Also, when the home appliance control device 100 determines that a user exists within a first distance from the first home appliance 120a, the home appliance control device 100 controls the first home appliance 120a to output a message via the first home appliance 120a. Therefore, the home appliance control device 100 may identify that the message is to be output from the first home appliance 120a. Also, according to an embodiment, the home appliance control device 100 may receive a message content request from the first home appliance 120a. In this case, when the message content request is received, the mobile device 110 and the home appliance control device 100 may determine that, after an elapse of a preset time, an output of a message is completed.

The message output completion information includes identification information of message output standby request information that has been completely output.

According to an embodiment of the present disclosure, the message output completion information may be broadcast via the home network 150. Therefore, when the output of the message is completed, the mobile device 110, the first home appliance 120a, and the second home appliance 120b, which are connected to the home network 150, receive the message output completion information.

When the message output completion information is received, in operation S720, the first home appliance 120a stops transmission of the distance information or the use state information. Also, when the message output completion information is received, in operation S722, the second home appliance 120b stops transmission of the distance information or the use state information. As described above, when a message output standby request is received, the first home appliance 120a and the second home appliance 120b operate in a message output standby mode. Afterward, when the message output completion information is broadcast from the home appliance control device 100, the first home appliance 120a and the second home appliance 120b end the message output standby mode.

According to an embodiment of the present disclosure, when the message output completion information is received, the mobile device 110 stops outputting a message. The message corresponds to a preset notification to be output from the mobile device 110. When the mobile device 110 receives the message output completion information indicating completion of an output of the message from the first home appliance 120a, the mobile device 110 may determine that an output of the message is completed, and may stop a notification with respect to the message.

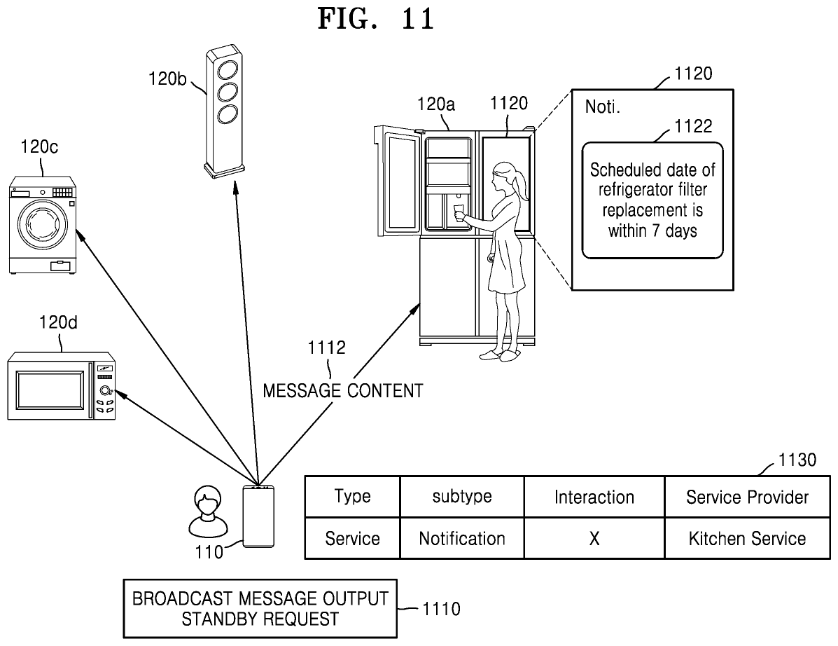

FIG. 11 illustrates a procedure for broadcasting a message output standby request, according to an embodiment of the present disclosure. FIG. 11 will now be described with reference to an example in which the mobile device 110 performs an operation of the home appliance control device 100. However, an embodiment of FIG. 11 is also applicable to a case in which the mobile device 110 and the home appliance control device 100 are implemented as separate devices.

According to an embodiment of the present disclosure, when a notification event occurs in the mobile device 110, a message output standby request 1130 is broadcast to a plurality of home appliances 120a, 120b, 120c, and 120d (1110). FIG. 11 is described using the message output standby request 1130 corresponding to a service type message.

When the message output standby request is broadcast via the home network 150 (1110), the plurality of home appliances 120a, 120b, 120c, and 120d connected to the home network 150 receive the message output standby request (1110). When a use operation of a user is detected in the first home appliance 120a, the first home appliance 120a transmits use state information to the mobile device 110. Also, the mobile device 110 transmits message content to the first home appliance 120a. When the first home appliance 120a receives message content 1112, the first home appliance 120a displays a message 1122 including the message content via a display 1120.

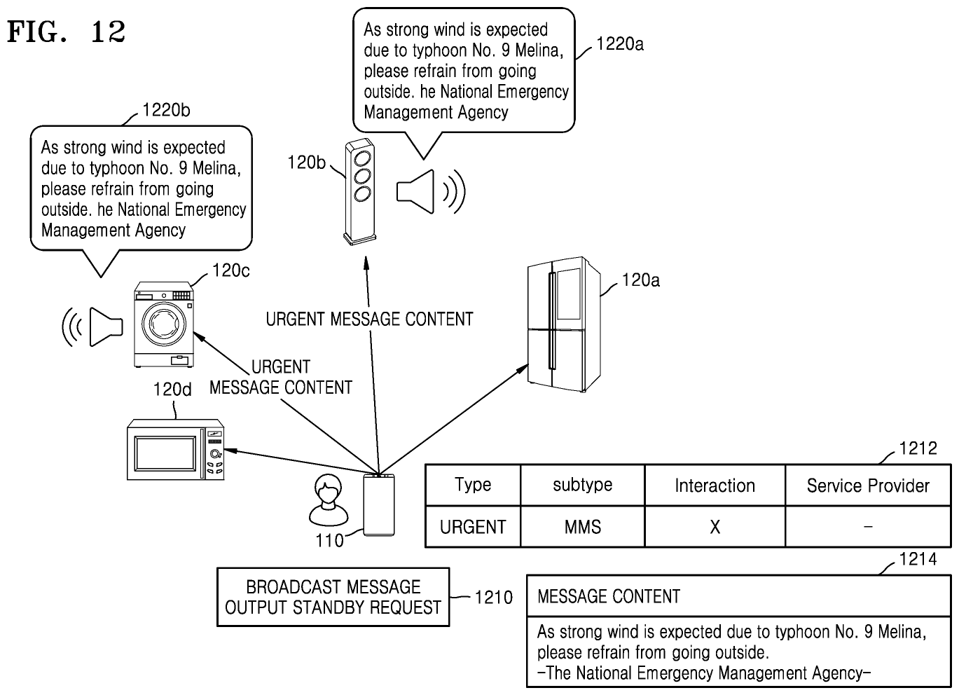

FIG. 12 illustrates a procedure for outputting an urgent message, according to an embodiment of the present disclosure. FIG. 12 will now be described with reference to an example in which the mobile device 110 performs an operation of the home appliance control device 100. However, the embodiment shown in FIG. 12 is also applicable to a case in which the mobile device 110 and the home appliance control device 100 are implemented as separate devices.

According to an embodiment of the present disclosure, with respect to the urgent message, the message may be output via the home appliances 120b and 120c each having a speaker. When an urgent-type notification event occurs, the mobile device 110 generates an urgent-type message corresponding to the urgent-type notification event. Also, the mobile device 110 generates an urgent-type message output standby request 1212 with respect to the urgent-type message. The mobile device 110 broadcasts the message output standby request 1212 via the home network 150 (1210).

The mobile device 110 transmits message content 1214 of an urgent message to the home appliances 120b and 120c each having a speaker and being from among the plurality of home appliances 120a, 120b, 120c, and 120d. The mobile device 110 pre-stores information about types of the output interface 248 included in the plurality of home appliances 120a, 120b, 120c, and 120d. For example, the mobile device 110 may store information indicating that the refrigerator 120a includes an LCD, the air conditioner 120b includes an LCD and a speaker, the washing machine 120c includes a speaker, and the oven 120d includes an LCD. The mobile device 110 transmits the message content 1214 of the urgent message to the home appliances 120b and 120c each having a speaker and being from among the registered plurality of home appliances 120a, 120b, 120c, and 120d. According to an embodiment of the present disclosure, when the mobile device 110 is in a use state while there is an urgent type message, the mobile device 110 may transmit the message content 1214 to the home appliances 120b and 120c each having a speaker, regardless of whether a user is detected within a first distance from the plurality of home appliances 120a, 120b, 120c, and 120d.

When the message content 1214 of the urgent message is received, the home appliances 120b and 120c each having a speaker convert the message content 1214 into an audio signal and output the audio signal (1220a and 1220b). The home appliances 120b and 120c may each include a TTS module, may convert the message content 1214 into an audio signal by using the TTS module, and may output the audio signal via the speaker.

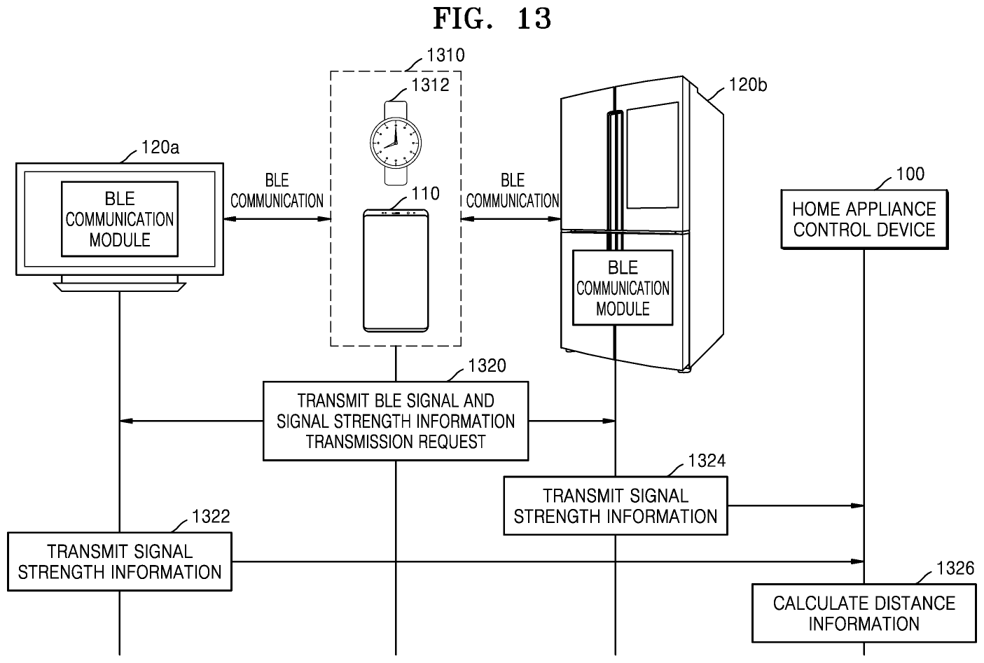

FIG. 13 illustrates a procedure for measuring a distance between a user and a home appliance, according to an embodiment of the present disclosure. For convenience of descriptions, FIG. 13 illustrates only two home appliances 120a and 120b. However, the number of home appliances 120a and 120b is not limited to 2, and according to embodiments, the number of home appliances 120a and 120b may vary.

According to an embodiment of the present disclosure, a distance between a user and the home appliance 120 may be calculated based on a strength of a BLE communication signal between the electronic device 1310 carried by the user and the home appliance 120.

According to an embodiment, the electronic device 1310 carried by the user corresponds to the mobile device 110 that has transmitted a message output standby request The mobile device 110 performs BLE communication with the home appliances 120a and 120b. Each of the mobile device 110 and the home appliances 120a and 120b may have a BLE communication module.

According to another embodiment, the electronic device 1310 carried by the user corresponds to a wearable device 1312. The wearable device 1312 may be implemented, for example, as a watch, an earphone, a band, glasses, or the like. The wearable device 1312 may be a device registered in the device management server 140. The wearable device 1312 may be a device registered in a same account in which the mobile device 110 logs. Also, the wearable device 1312 may be a device accessing the home network 150.

The electronic device 1310 performs BLE communication with the first home appliance 120a and the second home appliance 120b. In operation 1320, the electronic device 1310 transmits a BLE signal and a signal strength information transmission request to the first home appliance 120a and the second home appliance 120b. According to an embodiment, the electronic device 1310 includes a BLE beacon and transmits a BLE signal from the beacon.

In operation 1322, the first home appliance 120a detects a strength of the received BLE signal, and transmits signal strength information to the home appliance control device 100. The signal strength information may be received signal strength indication (RSSI) information indicating a strength of a signal received by the first home appliance 120a. Also, in operation 1324, the second home appliance 120b detects a strength of the received BLE signal, and transmits signal strength information to the home appliance control device 100.

Next, in operation 1326, the home appliance control device 100 calculates a distance between the user and the first home appliance 120a, based on the signal strength information received from the first home appliance 120a. Also, in operation 1326, the home appliance control device 100 calculates a distance between the user and the second home appliance 120b, based on the signal strength information received from the second home appliance 120b. A strength of a BLE signal is decreased as its distance to a device having transmitted the signal is increased. By using such characteristic of the BLE signal, the home appliance control device 100 may calculate a distance between the electronic device 1310 and the home appliances 120a and 120b, based on a strength of the BLE signal.

According to an embodiment of the present disclosure, the home appliance control device 100 calculates a distance between a user and each of the home appliances 120a and 120b by using only signal strength information of the mobile device 110.

According to another embodiment of the present disclosure, when first signal strength information of a BLE signal transmitted from the mobile device 110 and second signal strength information of a BLE signal transmitted from the wearable device 1312 are both available, the home appliance control device 100 calculates information of a distance between the user and each of the home appliances 120a and 120b by using both the first signal strength information and the second signal strength information. According to an embodiment, when the wearable device 1312 is currently worn, the home appliance control device 100 calculates distance information based on the second signal strength information. When the wearable device 1312 is not currently worn, the home appliance control device 100 calculates distance information based on the first signal strength information.

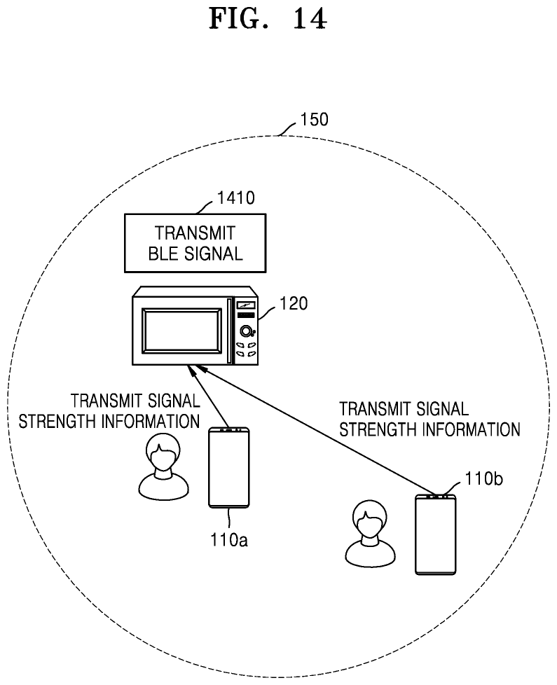

FIG. 14 illustrates a case in which a message output standby request is output from a plurality of mobile devices, according to an embodiment of the present disclosure.

According to an embodiment of the present disclosure, a plurality of mobile devices 110a and 110b may have an access into the home network 150. Each of the plurality of mobile devices 110a and 110b may generate a notification event. In this case, time periods in which the plurality of mobile devices 110a and 110b generate a notification event, output a message notification request, and thus, operate in a message output standby mode may overlap. In this case, according to an embodiment of the present disclosure, each home appliance 120 selects and outputs a message output standby request output from the mobile device 110a or 110b which is close to the corresponding home appliance 120.

With reference to FIG. 14, an operation of each device for a case where the message output standby request is output from the plurality of mobile devices 110a and 110b will now be described in detail.

The home appliance 120 receives a message output standby request from the first mobile device 110a and the second mobile device 110b. For example, the home appliance 120 may receive a second message output standby request from the second mobile device 110b while the home appliance 120 operates in a message output standby mode due to a first message output standby request from the first mobile device 110a. After the home appliance 120 receives two message output standby requests, the home appliance 120 measures a distance to the first mobile device 110a, and measures a distance to the second mobile device 110b.

During the message output standby mode, the home appliance 120 transmits a BLE signal to the first mobile device 110a and the second mobile device 110b. The home appliance 120 includes a BLE beacon, and transmits a BLE beacon signal to the first mobile device 110a and the second mobile device 110b. The first mobile device 110a generates signal strength information about a received BLE signal and transmits the generated signal strength information to the home appliance 120. Also, the second mobile device 110b generates signal strength information about a received BLE signal and transmits the generated signal strength information to the home appliance 120.

Distance measurement with respect to the first mobile device 110a and distance measurement with respect to the second mobile device 110b may be periodically performed during the message output standby mode.

When the home appliance 120 in the message output standby mode determines that one of the plurality of mobile devices 110a and 110b is within a first distance from the home appliance 120, the home appliance 120 outputs a message corresponding to a message output standby request received from the mobile device 110a or 110b which is within the first distance. When it is determined that all of the plurality of mobile devices 110a and 110b are within the first distance, the home appliance 120 outputs a message corresponding to a message output standby request output from a mobile device (e.g., the mobile device 110a) which is closer to the home appliance 120.

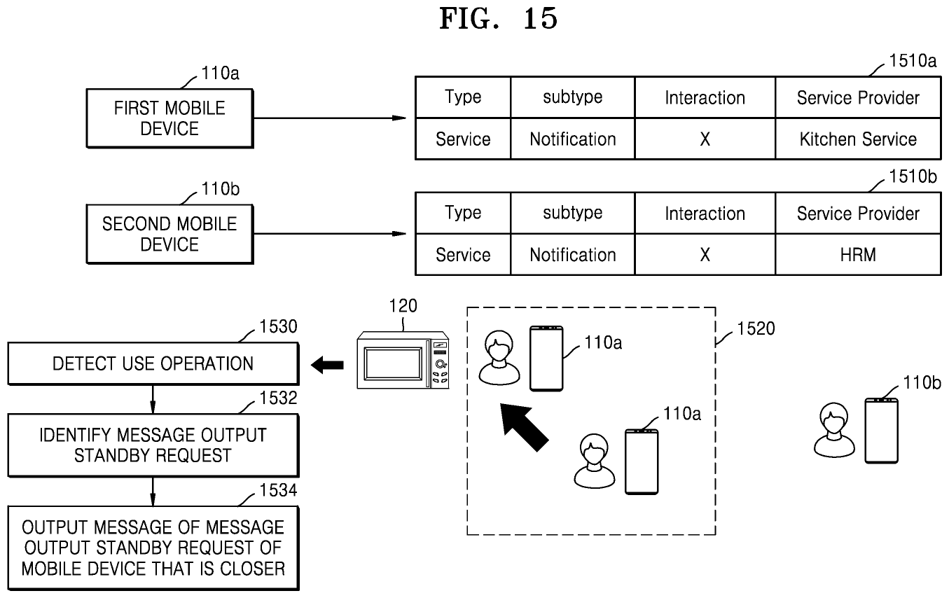

FIG. 15 illustrates a case in which a message output standby request is output from a plurality of mobile devices, according to an embodiment of the present disclosure.

According to an embodiment of the present disclosure, a message output standby request may be output from the plurality of mobile devices 110a and 110b. The home appliance 120 receives a first message output standby request 1510a from the first mobile device 110a, and receives a second message output standby request 1510b from the second mobile device 110b. The home appliance 120 operates in a message output standby mode.

When an operation of a user using the home appliance 120 is detected, the home appliance 120 outputs a message. For example, it is assumed that a user of the first mobile device 110a moves and manipulates the home appliance 120 (1520). When the user of the first mobile device 110a moves and manipulates the home appliance 120, the home appliance 120 detects a use operation of the user (1530).

Next, in operation 1532, when the home appliance 120 in a message output standby mode detects the use operation of the user, the home appliance 120 identifies a list of received message output standby requests. For example, the home appliance 120 identifies the first message output standby request 1510a and second message output standby request 1510b which are not processed.

Next, in operation 1534, the home appliance 120 measures a distance to each of the plurality of mobile devices 110a and 110b, and outputs a message of a message output standby request of a closer mobile device. The home appliance 120 measures a distance to the first mobile device 110a and a distance to the second mobile device 110b by using BLE signal strength information. When the home appliance 120 determines that the distance to the first mobile device 110a is closer than the distance to the second mobile device 110b, the home appliance 120 outputs a message corresponding to a first message output standby request output from the first mobile device 110a.

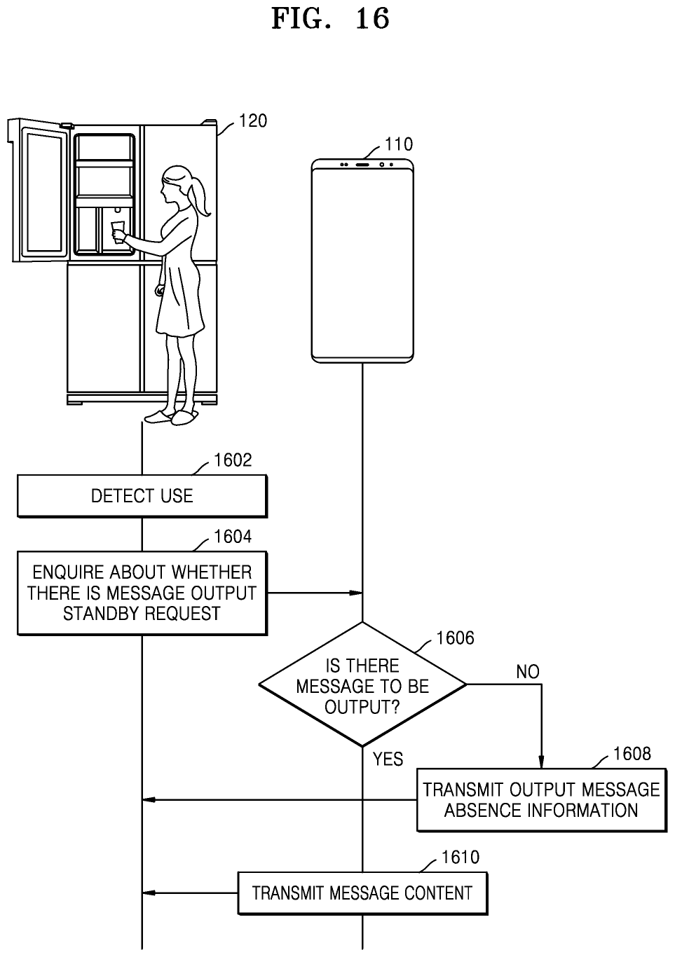

FIG. 16 illustrates a procedure for outputting a message when use of a home appliance is detected, according to an embodiment of the present disclosure.

According to an embodiment of the present disclosure, when the home appliance 120 detects a use operation of a user, the home appliance 120 may determine whether there is a message to output. Even when the home appliance 120 is not in a message output standby mode, when an operation of a user using the home appliance 120 is detected, the home appliance 120 may determine whether there is a message output standby request.

First, in operation 1602, the home appliance 120 detects a use operation of a user.

When the home appliance 120 detects the use operation of the user, in operation 1604, the home appliance 120 enquires about whether there is a message output standby request. The home appliance 120 may enquire about whether there is a message output standby request, via the home network 150. According to an embodiment, the home appliance 120 may enquire existence or non-existence of the message output standby request of the home appliance control device 100 or may enquire existence or non-existence of the message output standby request of the mobile device 110. According to another embodiment, the home appliance 120 may broadcast existence or non-existence of the message output standby request via the home network 150.

In operation 1606, the mobile device 110 receives an enquiry of existence or non-existence of the message output standby request, the mobile device 110 determines whether there is a message to output. When the mobile device 110 receives an enquiry of existence or non-existence of the message output standby request, the mobile device 110 determines whether the mobile device 110 is in a use state and whether there is a message of a notification event which is not yet output.

When there is a message to output, in operation 1610, the mobile device 110 transmits the message output standby request and message content to the home appliance 120. When the home appliance 120 receives the message output standby request and the message content, the home appliance 120 outputs the received message content via the output interface 248.

When there is not a message to output, in operation 1608, the mobile device 110 transmits output message absence information indicating there is no message to output, to the home appliance 120.

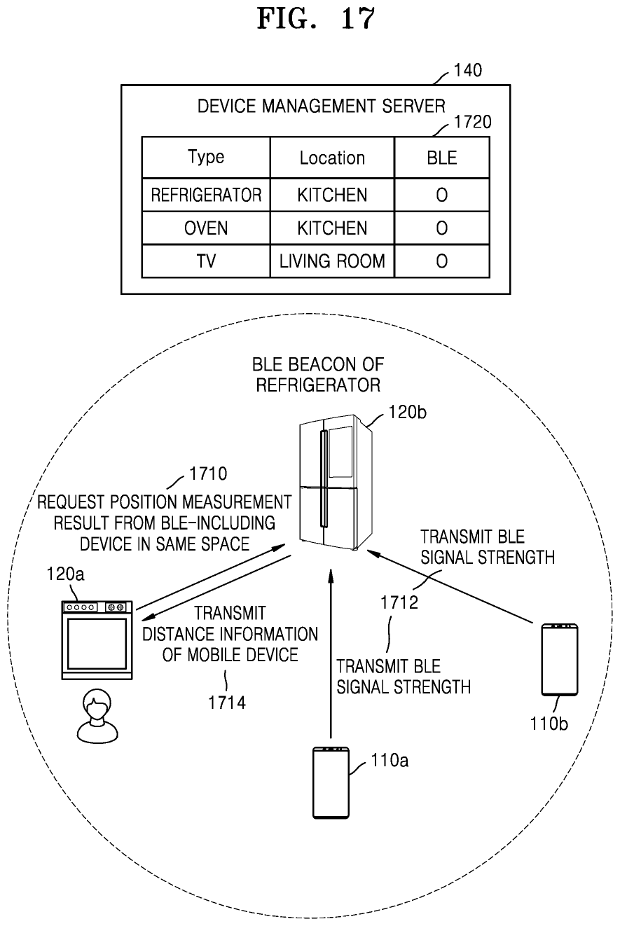

FIG. 17 illustrates a method of measuring a distance to a mobile device when a home appliance does not have a BLE communication module, according to an embodiment of the present disclosure.

According to an embodiment of the present disclosure, the first home appliance 120a may not have a BLE communication module. In this case, the first home appliance 120a may measure a distance to each of the mobile devices 110a and 110b via the second home appliance 120b that is positioned in the same space and has the BLE communication module. FIG. 17 is described with reference to an example in which the oven 120a corresponding to the first home appliance 120a does not have the BLE communication module, the refrigerator 120b corresponding to the second home appliance 120b has the BLE communication module, and the oven 120a and the refrigerator 120b are positioned in the same space.

In operation 1710, the oven 120a requests a position measurement result from the refrigerator 120b positioned in the same space. Home appliance attribute information 1720 about each of the home appliances 120a and 120b may be stored in the device management server 140. The home appliance attribute information 1720 may include at least one of type information (e.g., a refrigerator, an oven, a TV, etc.), space information (e.g., a kitchen, a living room, etc.), or BLE communication module inclusion information (e.g., included (O), not included (X)) of a home appliance.

According to an embodiment, the oven 120a may obtain the home appliance attribute information 1720 from the device management server 140, and may identify a home appliance positioned in the same space (e.g., a kitchen), based on the obtained home appliance attribute information 1720. The oven 120a identifies the refrigerator 120b positioned in the same space, based on the home appliance attribute information 1720, and transmits a position measurement result request to the refrigerator 120b.

According to another embodiment, the home appliance control device 100 obtains the home appliance attribute information 1720 from the device management server 140. The home appliance control device 100 may control, based on the obtained home appliance attribute information 1720, a home appliance (that is, the oven) not having the BLE communication module to obtain distance information from another home appliance (that is, the refrigerator) that is positioned in the same space and has the BLE communication module. For example, the home appliance control device 100 provides information about a home appliance having the BLE communication module and being positioned in the same space to the oven 120a, and controls the oven 120a to transmit a position measurement result request to the refrigerator 120b. As another example, the home appliance control device 100 transmits a position measurement result request to the refrigerator 120b so as to control the refrigerator 120b to transmit distance information to the oven 120a. As another example, the home appliance control device 100 transmits a position measurement result request to the refrigerator 120b, and receives distance information from the refrigerator 120b.

Next, in operation 1712, the refrigerator 120b receives BLE signal strength information from the mobile devices 110a and 110b. When two mobile devices 110a and 110b are connected to the home network 150, the refrigerator 120b receives BLE signal strength information from each of the two mobile devices 110a and 110b.

Next, in operation 1714, the refrigerator 120b transmits distance information of the mobile devices 110a and 110b to the oven 120a. According to an embodiment, the refrigerator 120b directly transmits distance information to the oven 120a. According to another embodiment, the refrigerator 120b transmits the distance information via the home appliance control device 100.

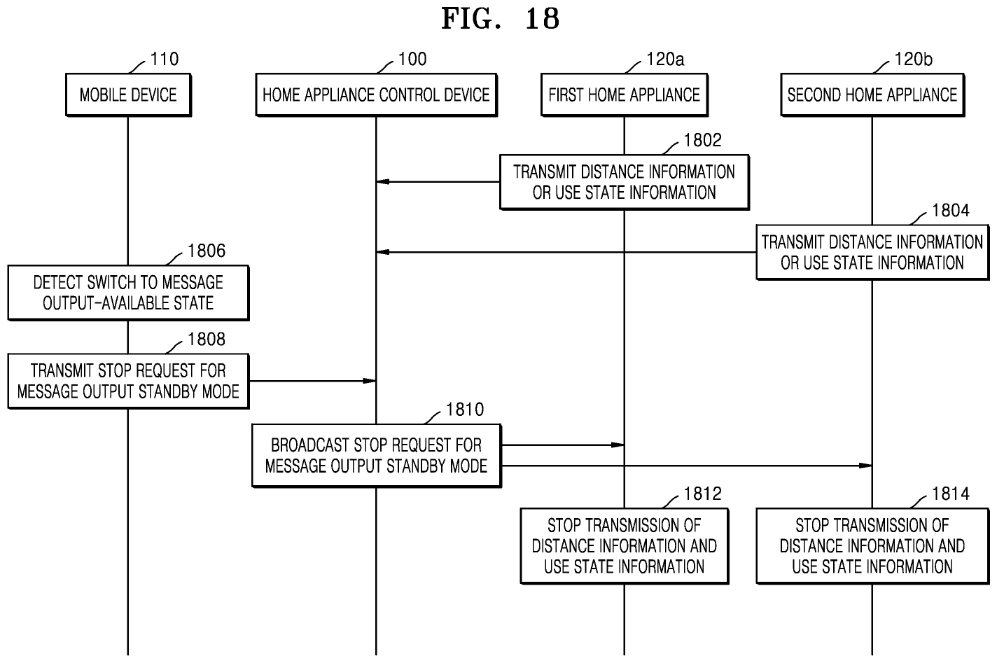

FIG. 18 illustrates a procedure for stopping a message output standby mode, according to an embodiment of the present disclosure.

According to an embodiment of the present disclosure, when a use state is stopped, the mobile device 110 may be switched to a message output-available state and may request the home appliance control device 100 and the home appliances 120a and 120b to stop a message output standby request. Operations of FIG. 18 indicate operations after the first home appliance 120a and the second home appliance 120b operate in a message output standby mode after a message output standby request is output to the first home appliance 120a and the second home appliance 120b.

First, in operation 1802, the first home appliance 120a in the message output standby mode transmits distance information or use state information to the home appliance control device 100. Also, in operation 1804, the second home appliance 120b in the message output standby mode transmits distance information or use state information to the home appliance control device 100.

In operation 1806, after the message output standby request, the mobile device 110 may detect that an operation state is switched from the use state to the message output-available state. For example, in a case where a video is reproducing and then reproduction of the video is ended, the mobile device 110 is switched to the message output-available state. As another example, in a case where a game is being played and then playing of the game is ended, the mobile device 110 is switched to the message output-available state. As another example, in a case where a call is ongoing and then the call is ended, the mobile device 110 is switched to the message output-available state. As another example, in a case where image-capturing is performed and then is ended, the mobile device 110 is switched to the message output-available state. As another example, while it is within a reference time from detection of a user input, when a time longer than the reference time elapses from the detection of the user input, the mobile device 110 is switched to the message output-available state. As another example, while it is within a reference time from an update of a GUI view based on a user input, when a time longer than the reference time elapses from the update of the GUI view based on the user input, the mobile device 110 is switched to the message output-available state. As another example, while a display is turned on, when the display is turned off, the mobile device 110 is switched to the message output-available state.

In operation 1808, the mobile device 110 generates a stop request for the message output standby request, based on the mobile device 110 being switched to the message output-available state, and transmits the stop request for the message output standby request to the home appliance control device 100.

In operation 1810, the home appliance control device 100 broadcasts the stop request for the message output standby request via the home network 150. The first home appliance 120a and the second home appliance 120b receive the broadcast stop request for the message output standby request.

According to an embodiment of the present disclosure, the mobile device 110 may broadcast the stop request for the message output standby request via the home network 150. In this case, operation 1810 may be omitted. The first home appliance 120a and the second home appliance 120b receive the stop request for the message output standby request broadcast from the mobile device 110.

When the first home appliance 120a and the second home appliance 120b receive the stop request for the message output standby request, the first home appliance 120a and the second home appliance 120b end the message output standby mode. When the message output standby mode is ended, in operation 1812, the first home appliance 120a stops an operation of transmitting the distance information and the use state information to the home appliance control device 100. Also, when the message output standby mode is ended, in operation 1814, the second home appliance 120b stops an operation of transmitting the distance information and the use state information to the home appliance control device 100.

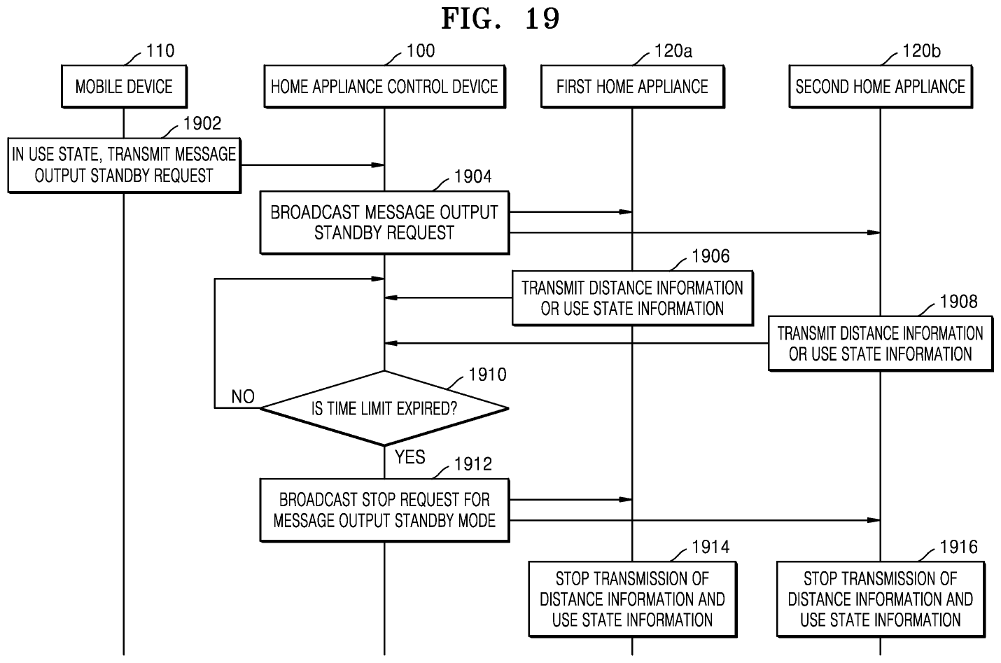

FIG. 19 illustrates a procedure for ending a message output mode, according to an embodiment of the present disclosure.

According to an embodiment of the present disclosure, when a message output is not completed within a time limit from a time when a message output standby request is transmitted, a message output standby mode according to the message output standby request may be stopped.

First, in operation 1902, when the mobile device 110 in a use state detects occurrence of a notification event, the mobile device 110 generates and transmits a message output standby request to the home appliance control device 100. In operation 1904, the home appliance control device 100 broadcasts the message output standby request via the home network 150.

When the message output standby request is broadcast, in operation 1906, the first home appliance 120a transmits distance information or use state information to the home appliance control device 100. Also, when the message output standby request is broadcast, in operation 1908, the second home appliance 120b transmits distance information or use state information to the home appliance control device 100.

In operation 1910, while the home appliance control device 100 operates in a message output standby mode in which a message output is not completed, the home appliance control device 100 determines whether a time limit for the message output is expired. According to an embodiment, the home appliance control device 100 determines whether a time limit is expired from a time the message output standby request being transmitted in operation 1902. According to another embodiment, the home appliance control device 100 determines whether a time limit is expired from a time the message output standby request being broadcast in operation 1904.

In a case where the time limit is expired while the message output is not completed, in operation 1912, the home appliance control device 100 broadcasts a stop request for the message output standby request.

When the first home appliance 120a and the second home appliance 120b receive the stop request for the message output standby mode in response to the message output standby request, the first home appliance 120a and the second home appliance 120b stop the message output standby mode. When the message output standby mode is ended, in operation 1914, the first home appliance 120a stops an operation of transmitting the distance information and the use state information to the home appliance control device 100. Also, when the message output standby mode is ended, in operation 1916, the second home appliance 120b stops an operation of transmitting the distance information and the use state information to the home appliance control device 100.

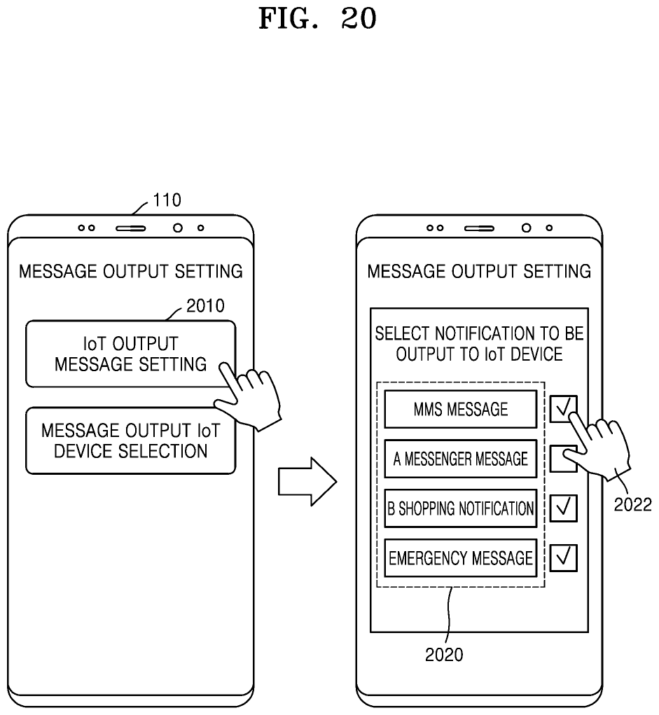

FIG. 20 illustrates a procedure for setting a type of a notification event to request a home appliance for a message output, according to an embodiment of the present disclosure.

According to an embodiment of the present disclosure, a user may set types of a notification event to request, via the mobile device 110, the home appliance 120 for a message output. According to an embodiment of the present disclosure, the user may select a type of a notification event by selecting an Internet of Things (IoT) output message setting menu 2010. The mobile device 110 provides notification event select options 2020 including a plurality of notification events. The user may select at least one of the notification event select options 2020 (2022), thereby selecting a type of a notification event to output a message via the home appliance 120. For example, the mobile device 110 may control, based on selection by the user, an MMS message, a B shopping notification, and an emergency message to be output via the home appliance 120, and an A messenger message not to be output via the home appliance 120.

When types of a notification event to output a message via the home appliance 120 are set by the user, the mobile device 110 may generate a message output standby request only for the notification event selected by the user. That is, when a notification event occurs while the mobile device 100 is in a use state, the mobile device 110 determines whether it is the notification event the user selected to output a message to the home appliance 120. When the detected notification event is a notification event the user selected to output a message to the home appliance 120, the mobile device 110 generates and outputs a message output standby request. When the detected notification event is not a notification event the user selected to output a message to the home appliance 120, the mobile device 110 does not output a message output standby request.

Referring to the embodiment of FIG. 20, user privacy may be strengthened. For privacy protection, a user may desire a particular notification event not to be output via the home appliance 120. According to an embodiment of FIG. 20, as a user selects a type of a notification event to be output via the home appliance 120, privacy protection for the user may be strengthened.

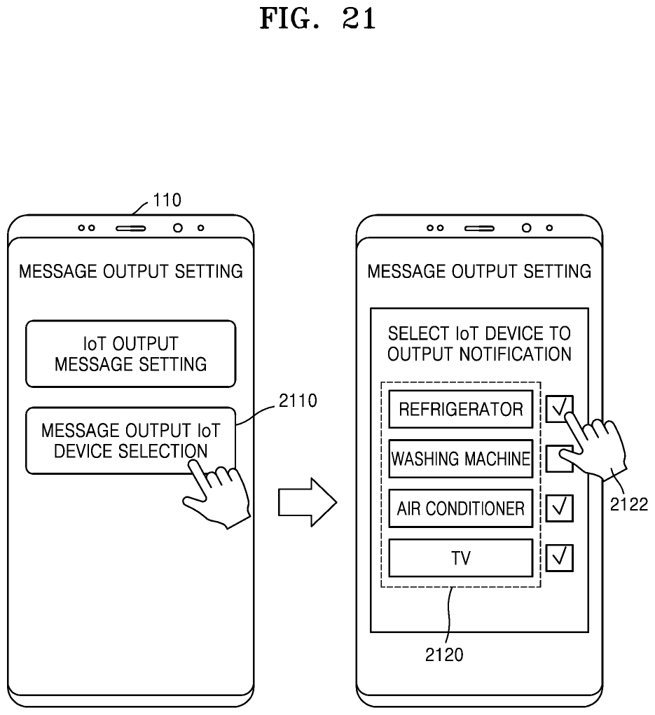

FIG. 21 illustrates a procedure for setting a home appliance to be requested to output a message, according to an embodiment of the present disclosure.

According to an embodiment of the present disclosure, a user may set, via the mobile device 110, the home appliance 120 to be requested to output a message. According to an embodiment of the present disclosure, the user may select a message output IoT device select menu 2110, thereby selecting the home appliance 120 to be requested to output a message. The mobile device 110 provides home appliance select options 2120 including at least one home appliance 120 connected to the home network 150. The user may select the home appliance 120 to output a message, by selecting at least one of the home appliance select options 2120 (2122). For example, based on selection by the user, the mobile device 110 may control a message corresponding to a notification event to be output via a refrigerator, an air conditioner, and a TV, and not to be output via a washing machine.

According to an embodiment of the present disclosure, the mobile device 110 may transmit a message output standby request to the home appliance 120 set by the user to output a message. According to an embodiment, the mobile device 110 transmits, to the home appliance control device 100, selection information about the home appliance 120 set by the user to output a message. When the home appliance control device 100 receives the message output standby request, the home appliance control device 100 transmits the message output standby request to the home appliance 120 set by the user to output a message.

Referring to the embodiment of FIG. 21, user privacy may be strengthened. For privacy protection, a user may desire a message corresponding to a notification event not to be output via the particular home appliance 120. For example, the user may desire the message to be output via a home appliance 120, which is mainly used by the user, and not to be output via a home appliance 120 that is used by other people as well as the user. According to the embodiment of FIG. 21, as a user selects the home appliance 120 to output a message, privacy protection for the user may be strengthened.

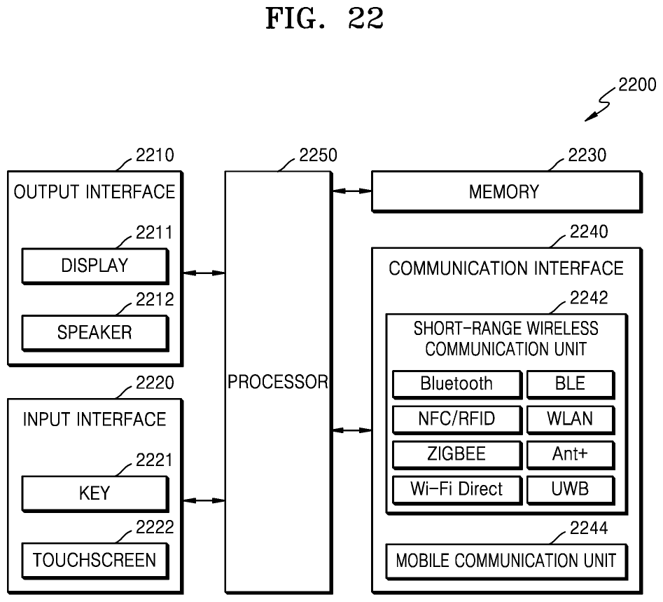

FIG. 22 illustrates a structure of a home appliance control device according to an embodiment of the present disclosure.

According to an embodiment of the present disclosure, a home appliance control device 2200 includes an output interface 2210, an input interface 2220, a memory 2230, a communication interface 2240, and a processor 2250. The home appliance control device 2200 may include various combinations of elements shown in FIG. 22, and not all elements shown in FIG. 22 are necessary elements.

The home appliance control device 2200 of FIG. 22 corresponds to the home appliance control device 100 described with reference to FIG. 1, the communication interface 2240 corresponds to the communication interface 220 described with reference to FIG. 2, and the processor 2250 corresponds to the processor 210 described with reference to FIG. 2.

The output interface 2210 may include at least one of a display 2211 or a speaker 2212 or a combination thereof. The output interface 2210 outputs various notifications, messages, information, or the like which are generated in the processor 2250.

The input interface 2220 may include a key 2221, a touchscreen 2222, a touch pad, or the like. The input interface 2220 receives and transmits a user input to the processor 2250.

The memory 2230 stores various information, data, instructions, programs, or the like which are required for operations of the home appliance control device 2200. The memory 2230 may include at least one of a volatile memory or a non-volatile memory or a combination thereof. The memory 2230 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc. Also, the home appliance control device 2200 may run a web storage or a cloud server which performs a storage function on Internet.

The communication interface 2240 may include at east one of the short-range wireless communication unit 2242 or the mobile communication unit 2244 or a combination thereof. The communication interface 2240 may include at least one antenna for wirelessly communicating with other device.

The short-range wireless communication unit 2242 may include a Bluetooth communication unit, a BLE communication unit, a near field communication (NFC) unit, a wireless local area network (WLAN) (or Wi-Fi) communication unit, a ZigBee communication unit, an Infrared Data Association (IrDA) communication unit, a Wi-Fi Direct (WFD) communication unit, an ultra-wideband (UWB) communication unit, an Ant+communication unit, a microwave (μWave) communication unit but the present disclosure is not limited thereto.

The mobile communication unit 2244 transmits and receives wireless signals to and from at least one of a base station, an external terminal, or a server in a mobile communication network. Herein, the wireless signals may include various types of data based on transmission and reception of voice call signals, video call signals, or text/multimedia messages.

The processor 2250 controls all operations of the home appliance control device 2200. The processor 2250 may control elements of the home appliance control device 2200 by executing a program stored in the memory 2230.

According to an embodiment of the present disclosure, the processor 2250 may include a separate neural processing unit (NPU) for performing an operation of a machine learning model. Also, the processor 2250 may include a central processing unit (CPU), a graphics processing unit (GPU), or the like.

A term “module” used in various embodiments of the present specification may include a unit implemented with hardware, software, or firmware, and may be mutually compatibly used with a term such as logic, a logic block, a part, or a circuit. The module may be an element configured as one piece or a minimum unit of the element, which performs one or more functions, or a part thereof. For example, according to an embodiment, the module may be implemented in the form of an application specific integrated circuit (ASIC).

Various embodiments of the present specification may be implemented as software (e.g., a program) including one or more instructions stored in a storage medium readable by a machine (e.g., the home appliance control device 100, the mobile device 110, or the home appliance 120). For example, a processor of a machine (e.g., the home appliance control device 100, the mobile device 110, or the home appliance 120) may call at least one of the one or more stored instructions from the storage medium and execute the instruction. This may enable the machine to operate to perform at least one function according to the at least one called instruction. The one or more instructions may include a code generated by a compiler or a code executable by an interpreter. A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium.

According to an embodiment, the method according to various embodiments disclosed in the present specification may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store (e.g.: Play Store™) or directly between two user apparatuses (e.g.: smartphones). In a case of online distribution, at least a portion of the computer program product may be at least temporarily stored or temporarily generated in a machine-readable storage medium such as a manufacturer's server, a server of an application store, or a memory of a relay server.

According to various embodiments, each of the above-described elements (e.g., a module or program) may include a single entity or a plurality of entities, some of which may be separately disposed on other elements. According to various embodiments, one or more of the above-described elements or operations may be omitted or one or more other elements or operations may be added. Alternatively or additionally, a plurality of elements (e.g., modules or programs) may be integrated into one element. In this case, the integrated element may perform one or more functions of each of the plurality of elements in a manner that is the same as or similar to a corresponding element of the plurality of elements before the integration. According to various embodiments, operations performed by a module, a program, or other elements may be executed sequentially, in parallel, repeatedly, or heuristically, or one or more of the operations may be executed in a different order or omitted, or one or more other operations may be added.

1. A home appliance control device comprising:
a communication interface; and
at least one processor configured to
transmit, based on a message output standby request being received from a mobile device, the message output standby request to at least one home appliance via the communication interface,
determine whether a user exists within a first distance from at least one of the at least one home appliance, and
control, based on determining that the user exists within the first distance from a first home appliance from among the at least one home appliance, the first home appliance to output a message corresponding to the message output standby request.

2. The home appliance control device of claim 1, wherein the at least one processor is configured to determine, based on detecting an operation of a user using the first home appliance, that the user exists within the first distance from the first home appliance.

3. The home appliance control device of claim 1, wherein the at least one processor is configured to
calculate a distance between the mobile device and each of the at least one home appliance, based on a strength of a Bluetooth low energy (BLE) communication signal between the mobile device and each of the at least one home appliance, and
when a calculated distance between the mobile device and the first home appliance is within the first distance, determine that the user exists within the first distance from the first home appliance.

4. The home appliance control device of claim 3, wherein the at least one processor is configured to, based on a distance between the mobile device and a third home appliance, the distance being calculated with respect to the third home appliance having same space information as a second home appliance and comprising a BLE communication module, calculate a distance between the mobile device and the second home appliance not comprising a BLE communication module from among the at least one home appliance.

5. The home appliance control device of claim 1, wherein the at least one processor is configured to
broadcast the message output standby request to the at least one home appliance via the communication interface, based on determining that the mobile device is in a use state, and
receive, after broadcasting the message output standby request, distance information indicating whether a user exists within the first distance, from each of the at least one home appliance.

6. The home appliance control device of claim 5, wherein the at least one processor is configured to,
based on determining that the user exists within the first distance, based on the distance information received from the first home appliance,
control the first home appliance to output the message, and
control, by transmitting message output completion information indicating an output of the message corresponding to the message output standby request to other home appliance excluding the first home appliance from among the at least one home appliance, the other home appliance not to output the message corresponding to the message output standby request, and stop an operation of receiving the distance information from the at least one home appliance.

7. The home appliance control device of claim 5, wherein the at least one processor is configured to, based on determining that a user exists within the first distance from the first home appliance after broadcasting the message output standby request, transmit message content corresponding to the message output standby request to the first home appliance.

8. The home appliance control device of claim 5, wherein the at least one processor is configured to, based on determining that the mobile device is switched from the use state to a message output-available state, broadcast a stop request for a message output standby mode in response to the message output standby request to the at least one home appliance, and stop receiving of the distance information from the at least one home appliance.

9. The home appliance control device of claim 1, wherein the at least one processor is configured to, when the message output standby request is an urgent type, control a home appliance to output a message as an audio signal corresponding to the message output standby request, the home appliance comprising a speaker and being from among the at least one home appliance.

10. The home appliance control device of claim 1, wherein the at least one processor is configured to,
based on receiving a first message output standby request from a first mobile device and receiving a second message output standby request from a second mobile device, obtain a distance between the first mobile device and each of the at least one home appliance, and obtain a distance between the second mobile device and each of the at least one home appliance, and
when it is identified that the first mobile device and the second mobile device exist within the first distance from the first home appliance, outputting, via the first home appliance, a message corresponding to a message output standby request transmitted from a mobile device which is closer to the first home appliance from among the first mobile device and the second mobile device.

11. The home appliance control device of claim 1, wherein the at least one processor is configured to, based on receiving selection information about a home appliance set to output a message, transmit the message output standby request to the home appliance selected from the selection information from among the at least one home appliance, and not to transmit the message output standby request to a home appliance that is not selected from the selection information.

12. A home appliance control method comprising:
transmitting, based on a message output standby request being received from a mobile device, the message output standby request to at least one home appliance;
determining whether a user exists within a first distance from at least one of the at least one home appliance; and
controlling, based on determining that the user exists within the first distance from a first home appliance from among the at least one home appliance, the first home appliance to output a message corresponding to the message output standby request.

13. The home appliance control method of claim 12, wherein the determining of whether the user exists within the first distance comprises determining, based on detecting an operation of a user using the first home appliance, that the user exists within the first distance from the first home appliance.

14. The home appliance control method of claim 12, wherein the determining of whether the user exists within the first distance comprises:
calculating a distance between the mobile device and each of the at least one home appliance, based on a strength of a Bluetooth low energy (BLE) communication signal between the mobile device and each of the at least one home appliance; and
when a calculated distance between the mobile device and the first home appliance is within the first distance, determining that the user exists within the first distance from the first home appliance.

15. A non-transitory computer-readable recording medium having recorded thereon a program for performing, on a computer, the home appliance control method of claim 12.
